(19) United States
(12) Patent Application Publication
(10) Pub. No.: US 2025/0264609 A1
(43) Pub. Date: Aug. 21, 2025

(54) AUTONOMOUS MOVING APPARATUS AND COMPOSITE UNIT OF SPEAKER-MICROPHONE FOR AUTONOMOUS MOVING APPARATUS

(71) Applicant: ROHM CO., LTD., Kyoto (JP)

(72) Inventor: Hiroshi YAGUMA, Kyoto (JP)

(73) Assignee: ROHM CO., LTD., Kyoto (JP)

(21) Appl. No.: 19/202,690

(22) Filed: May 8, 2025

Related U.S. Application Data
(63) Continuation of application No. PCT/JP2023/039925, filed on Nov. 6, 2023.

(30) Foreign Application Priority Data
Nov. 11, 2022 (JP) 2022-181345

(51) Int. Cl. G01S 15/931; G01S 7/521; H04R 1/02; H04R 1/08

(52) U.S. Cl. CPC G01S 15/931; G01S 7/521; H04R 1/025; H04R 1/08; G01S 2015/937

(57) ABSTRACT

An autonomous moving apparatus includes: a first speaker that is attached to the vehicle body and transmits an acoustic wave toward an area including a front direction of the vehicle body; a first microphone and a second microphone that is attached to the vehicle body, receives an acoustic wave reflected by an object. When viewed from a vertical direction, the first speaker, the first microphone, and the second microphone are located on an outside or an outer periphery of the vehicle body. The first speaker is interposed between the first microphone and the second microphone in a left-right direction perpendicular to the front direction. Distances from the first speaker or a center of gravity of a plurality of speakers including the first speaker, to each of the first microphone and the second microphone in the left-right direction are equal.

### CROSS REFERENCE TO RELATED APPLICATIONS AND INCORPORATION BY REFERENCE

This is a continuation application (CA) of PCT Application No. PCT/JP2023/039925, filed on Nov. 6, 2023, which claims priority to Japan Patent Application No. P2022-181345 filed on Nov. 11, 2022 and is based upon and claims the benefit of priority from prior Japanese Patent Application No. P2022-181345 filed on Nov. 11, 2022 and PCT Application No. PCT/JP2023/039925, filed on Nov. 6, 2023; the entire contents of each of which are incorporated herein by reference.

### TECHNICAL FIELD

The present disclosure relates to an autonomous moving apparatus and a composite unit of a speaker-microphone for an autonomous moving apparatus.

### BACKGROUND

There are conventionally known autonomous traveling vehicles adopting Simultaneous Localization And Mapping (SLAM). By using an external sensor such as a camera or a laser sensor and an internal sensor such as an encoder or a gyroscope in combination for each autonomous traveling vehicle, each autonomous traveling vehicle estimates a position thereof and automatically generates a travel path, and this enables automatic avoidance of an obstacle without being limited by a fixed route, for example. The autonomous traveling vehicles eliminate the necessity for infrastructure such as wires embedded in the floor or markings on the floor. SLAM using a camera may be referred to as Visual SLAM, and SLAM using a laser sensor may be referred to as Light Detection And Ranging (LIDAR) SLAM.
Patent Literature 1: JP 2020-181485 A

### BRIEF DESCRIPTION OF DRAWINGS

FIG. 1 is a schematic diagram for explaining an operation summary of an autonomous movement system including an autonomous moving apparatus according to a plurality of embodiments.

FIG. 2 is an explanatory diagram showing a situation in which the autonomous moving apparatus travels on a planar travel path where a plurality of obstacles p1 to p4 are present, and travels toward a destination P1.

FIG. 3 is a block diagram showing an example of a configuration of the autonomous moving apparatus according to the plurality of embodiments.

FIG. 4 is a block diagram showing an example of an echolocation configuration of one speaker and two microphones in an autonomous moving apparatus 100 according to the present embodiment.

FIG. 5 is a block diagram showing details of each component in the echolocation configuration shown in FIG. 4.

FIG. 6A is a plan view showing the autonomous moving apparatus 100 having layouts of a speaker and microphones for increasing the difference in sound pressures of acoustic waves received by a pair of left and right first microphone 51L and second microphone 51R (part 1).

FIG. 6B is a plan view showing the autonomous moving apparatus 100 having layouts of a speaker and microphones for increasing the difference in sound pressures of acoustic waves received by the pair of left and right first microphone 51L and second microphone 51R (part 2).

FIG. 6C is a plan view showing the autonomous moving apparatus 100 having layouts of a speaker and microphones for increasing the difference in sound pressures of acoustic waves received by the pair of left and right first microphone 51L and second microphone 51R (part 3).

FIG. 7A is a plan view showing the autonomous moving apparatus 100 having layouts of speakers and microphones for increasing the difference in sound pressures of acoustic waves received by the pair of left and right first microphone 51L and second microphone 51R (part 4).

FIG. 7B is a plan view showing the autonomous moving apparatus 100 having layouts of speakers and microphones for increasing the difference in sound pressures of acoustic waves received by the pair of left and right first microphone 51L and second microphone 51R (part 5).

FIG. 7C is a plan view showing the autonomous moving apparatus 100 having layouts of speakers and microphones for increasing the difference in sound pressures of acoustic waves received by the pair of left and right microphones 51L and 51R (part 6).

FIG. 7D is a plan view showing the autonomous moving apparatus 100 having layouts of speakers and microphones for increasing the difference in sound pressures of acoustic waves received by the pair of left and right microphones 51L and 51R (part 7).

FIG. 7E is a side view showing a layout of the autonomous moving apparatus 100 for increasing sound pressures of acoustic waves received by the first microphone 51L and the second microphone 51R from a front direction or an oblique front direction (part 1).

FIG. 7F is a side view showing a layout of the autonomous moving apparatus 100 for increasing sound pressures of acoustic waves received by the first microphone 51L and the second microphone 51R from the front direction or the oblique front direction (part 2).

FIG. 7G is a side view showing a layout of a composite unit 300 for increasing sound pressures of acoustic waves received by the first microphone 51L and the second microphone 51R from the front direction or the oblique front direction (part 1).

FIG. 7H is a side view showing a layout of the composite unit 300 for increasing sound pressures of acoustic waves received by the first microphone 51L and the second microphone 51R from the front direction or the oblique front direction (part 2).

FIG. 8 is a plan view showing the autonomous moving apparatus having the composite unit 300 for an autonomous moving apparatus, with layouts of a speaker and microphones for increasing the difference in sound pressures of acoustic waves received by the pair of left and right microphones 51L and 51R.

FIG. 9 is a plan view showing a structure of a casing 210 for reducing a sound pressure of an acoustic wave (noise) coming from a rear direction.

FIG. 10A is a plan view showing a modified example of an embodiment for reducing a sound pressure of an acoustic wave (noise) coming from the rear direction (part 1).

FIG. 10B is a plan view showing a modified example of the embodiment for reducing a sound pressure of an acoustic wave (noise) coming from the rear direction (part 2).

FIG. 10C is a plan view showing a modified example of the embodiment for reducing a sound pressure of an acoustic wave (noise) coming from the rear direction (part 3).

FIG. 10D is a plan view sowing a modified example of the embodiment for reducing a sound pressure of an acoustic wave (noise) coming from the rear direction (part 4).

FIG. 11 is a plan view showing a modified example of the embodiment for reducing a sound pressure of an acoustic wave (noise) coming from the rear direction (part 5).

FIG. 12 is a plan view showing a modified example of the embodiment for reducing a sound pressure of an acoustic wave (noise) coming from the rear direction (part 6).

FIG. 13 is a plan view showing an example of a structure of the composite unit for increasing sound pressures of acoustic waves coming from oblique front directions, among acoustic waves received by the first microphone 51L and the second microphone 51R.

FIG. 14A is a plan view showing a modified example of an embodiment for increasing sound pressures of acoustic waves coming from the oblique front directions, among acoustic waves received by the first microphone 51L and the second microphone 51R (part 1).

FIG. 14B is a plan view showing a modified example of the embodiment for increasing sound pressures of acoustic waves coming from the oblique front directions, among acoustic waves received by the first microphone 51L and the second microphone 51R (part 2).

FIG. 15A is a plan view showing a modified example of the embodiment for increasing sound pressures of acoustic waves coming from the oblique front directions, among acoustic waves received by the first microphone 51L and the second microphone 51R (part 3).

FIG. 15B is a plan view showing a modified example of the embodiment for increasing sound pressures of acoustic waves coming from the oblique front directions, among acoustic waves received by the first microphone 51L and the second microphone 51R (part 4).

FIG. 16 is a plan view showing a modified example of the embodiment for increasing sound pressures of acoustic waves coming from the oblique front directions, among acoustic waves received by the first microphone 51L and the second microphone 51R (part 5).

FIG. 17A is a plan view showing a modified example of the embodiment for increasing sound pressures of acoustic waves coming from the oblique front directions, among acoustic waves received by the first microphone 51L and the second microphone 51R (part 6).

FIG. 17B is a plan view showing a modified example of the embodiment for increasing sound pressures of acoustic waves coming from the oblique front directions, among acoustic waves received by the first microphone 51L and the second microphone 51R (part 7).

FIG. 18A is a plan view showing an example of a structure of the composite unit 300 for reducing sound pressures of acoustic waves coming from right and left opposite sides, among acoustic waves received by the first microphone 51L and the second microphone 51R.

FIG. 18B is a plan view showing another example of a structure of the composite unit 300 for reducing sound pressures of acoustic waves coming from the right and left opposite sides, among acoustic waves received by the first microphone 51L and the second microphone 51R (part 1).

FIG. 18C is a plan view showing another example of a structure of the composite unit 300 for reducing sound pressures of the acoustic waves coming from the right and left opposite sides, among acoustic waves received by the first microphone 51L and the second microphone 51R (part 2).

FIG. 19 is a side view showing an example of a structure of the composite unit 300 for reducing sound pressures of acoustic waves reflected by an unevenness 63 on a ground 62, among acoustic waves received by the first microphone 51L and the second microphone 51R.

FIG. 20 is a plan view showing an example of a structure of the composite unit 300 for increasing sound pressures of acoustic waves coming from a lateral direction of the composite unit 300 to prevent an object 60A in the lateral direction from being entangled.

FIG. 21 is a plan view showing an example of a structure of the composite unit 300 for increasing sound pressures of acoustic waves coming from a front direction of the autonomous moving apparatus 100 to prevent collision with the object 60A in the front direction.

FIG. 22A is a plan view showing an example of a structure of the composite unit 300 for increasing sound pressures of acoustic waves coming from at least one of a front direction and a lateral direction, while increasing sound pressures of acoustic waves coming from oblique front directions to the pair of left and right microphones 51L and 51R.

FIG. 22B is a plan view showing another example of a structure of the composite unit 300 for increasing sound pressures of acoustic waves coming from at least one of a front direction and a lateral direction, while increasing sound pressures of acoustic waves coming from the oblique front directions to the pair of left and right microphones 51L and 51R.

FIG. 23A is a plan view showing another modified example of the number and arrangement of microphones and speakers of the autonomous moving apparatus 100 (part 1).

FIG. 23B is a plan view showing another modified example of the number and arrangement of microphones and speakers of the autonomous moving apparatus 100 (part 2).

FIG. 23C is a plan view showing another modified example of the number and arrangement of microphones and speakers of the autonomous moving apparatus 100 (part 3).

FIG. 23D is a plan view showing another modified example of the number and arrangement of microphones and speakers of the autonomous moving apparatus 100 (part 4).

FIG. 23E is a plan view showing another modified example of the number and arrangement of microphones and speakers of the autonomous moving apparatus 100 (part 5).

### DETAILED DESCRIPTION

An autonomous moving apparatus, an autonomous movement system, and a composite unit of a speaker-microphone for an autonomous moving apparatus according to a plurality of embodiments will be described below in detail with reference to the drawings. It should be noted that embodiments described below shows exhaustive or specific examples. Numerical values, shapes, materials, constituent elements, and installation positions and connection forms of constituent elements described in the following embodiments are examples and are not intended to be limited to those of the present disclosure. Further, among constituent elements in the following embodiments, constituent elements not recited in independent claims indicating the most significant concept are described as optional constituent elements. Still further, the dimensional ratios in the drawings are exaggerated for illustrative purposes and may differ from the actual ratios.

In addition, the following embodiments and modified examples thereof may include similar constituent elements, and therefore the similar constituent elements are denoted with a common reference numeral to omit duplicated descriptions thereof.

### (Outline of Autonomous Moving Apparatus)

The autonomous moving apparatus according to the plurality of embodiments can be used in the internal space or, in some cases, in the external space of buildings such as houses and offices and structures such as factories, and has a configuration of autonomously reaching a target object, for example. Further, by using a propeller or the like which enables aerial movement for a moving mechanism, a flying object such as what is referred to as a drone can autonomously reach a target object, for example. The autonomous moving apparatus can be used for moving objects such as vehicles including passenger cars and buses, aircraft, spacecraft, ships, and submersibles.

The autonomous moving apparatus does not use an imaging device such as a camera, LiDAR, and radar, but reaches the target object while avoiding an obstacle using information output by the target object. Although there are no particular limitations, example of the information output by the target object include radio waves or high-frequency electromagnetic waves. Hereafter, a description will be given by taking radio waves as examples. The autonomous moving apparatus receives radio waves such as beacons using a plurality of antennas thereof, uses a technology for estimating an incoming direction of radio waves to estimate a direction of the target object which emits the radio waves, and moves in the estimated direction. When an obstacle is present outside a line-of-sight between the target object and the autonomous moving apparatus, the autonomous moving apparatus may move in an incoming direction of radio waves reflected by the obstacle. However, the autonomous moving apparatus may receive radio waves directly received from the target object during movement. In this case, the autonomous moving apparatus can change a movement direction thereof in a direction of the target object on the way to move toward the obstacle. As a result, the autonomous moving apparatus can move toward the target object while avoiding the obstacle. In addition, when the obstacle is present on the line-of-sight between the target object and the autonomous moving apparatus, the autonomous moving apparatus can detect the presence of the obstacle, because the reception intensity of the radio waves oscillates as the autonomous moving apparatus moves toward the obstacle. In this way, the autonomous moving apparatus can reach the target object, while avoiding the obstacle, by continuously moving in a direction where the reception intensity of the radio waves is high, while estimating the incoming direction of the radio waves.

As described above, it is not necessary for the autonomous moving apparatus to have an imaging device such as a CCD camera, LiDAR, and radar for route search which have been employed in a conventional technology. In other words, the autonomous moving apparatus of the present disclosure can reach the target object which outputs the information by having the plurality of antennas and a control unit and a drive unit for the autonomous moving apparatus to move in an incoming direction of information, while measuring the intensity of the information. In addition, acoustic waves emitted from a speaker mounted in the autonomous moving apparatus are reflected by objects in the periphery of the autonomous moving apparatus, and based on the acoustic waves received by a plurality of microphones, the movement direction of the autonomous moving apparatus can be set. Therefore, the movement direction of the autonomous moving apparatus can be set by avoiding a narrow travel path or an intricate and complicated travel path. As a result, the autonomous moving apparatus can reach the target object while selecting a suitable travel path that is less affected by objects (including obstacles) in the periphery of the autonomous moving apparatus.

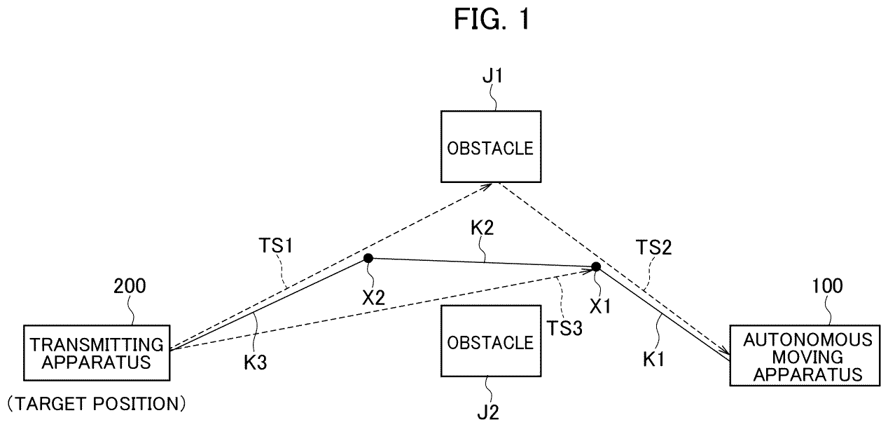

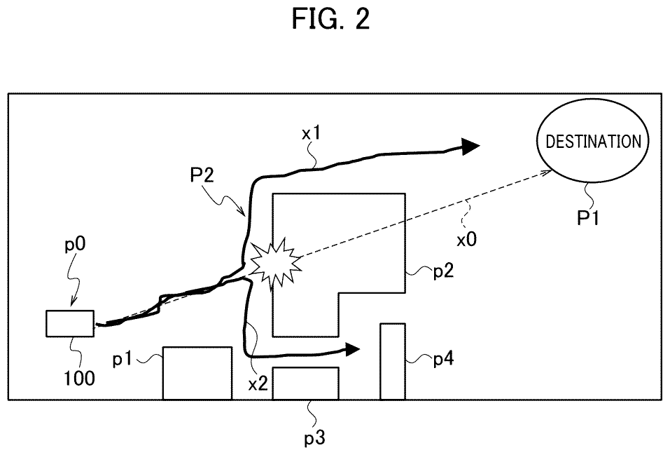

Next, with reference to FIGS. 1 and 2, a general description will be given regarding an operation principle of an autonomous moving apparatus 100 according to a plurality of embodiments and an autonomous movement system 1000 including the autonomous moving apparatus 100.

### (Outline of Digital Pheromone)

First, with reference to FIG. 1, a mechanism (digital pheromone) will be described in which the autonomous moving apparatus 100 continuously moves in a direction where the reception intensity of a radio wave such as a beacon is high, while estimating an incoming direction of the radio wave, and as a result the autonomous moving apparatus 100 reaches a target object (transmitting apparatus 200), while avoiding obstacles J1 and J2. The autonomous moving apparatus 100 receives a radio wave transmitted from the transmitting apparatus 200 (corresponding to target object) arranged at a target position. Since a line-of-sight between the autonomous moving apparatus 100 and the transmitting apparatus 200 is blocked by the obstacle J2, the autonomous moving apparatus 100 receives the radio wave via a path K3→a path K2→a path K1. There is a possibility that the autonomous moving apparatus 100 receives a radio wave from the line-of-sight direction depending on the size of the obstacle J2 and a frequency of a beacon. However it is assumed that a radio wave received via the path K1 has the highest intensity. The autonomous moving apparatus 100 estimates an incoming direction of a radio wave with the highest intensity using a plurality of antennas mounted on the autonomous moving apparatus 100, and moves based on the estimated incoming direction.

The autonomous moving apparatus 100 moving on the path K1 toward the obstacle J1 continuously moves on the path K1 toward the obstacle J1, because the reception intensity of the radio wave increases as the autonomous moving apparatus 100 approaches the obstacle J1. However, when the autonomous moving apparatus 100 reaches a position x1, the transmitting apparatus 200 appears ahead of the line-of-sight of the autonomous moving apparatus 100, and therefore the autonomous moving apparatus 100 can directly receive a radio wave TS3. Since the reception intensity of the radio wave TS3 is higher than that of a radio wave TS2 at the position x1, the autonomous moving apparatus 100 attempts to change a movement direction to an incoming direction of the radio wave TS3. The autonomous moving apparatus 100 can move on the line of the incoming direction of the radio wave TS3, but in that case, there is a possibility that the autonomous moving apparatus 100 collides with the obstacle J2. Therefore, from a fact that the autonomous moving apparatus 100 could not receive the radio wave TS3 until the autonomous moving apparatus 100 reaches the position x1 on the path K1, and from the estimated incoming direction of the radio wave TS3 with a high intensity received when the autonomous moving apparatus 100 is at the position x1, the autonomous moving apparatus 100 recognizes the presence of the obstacle J2 and moves in a direction of the path K2. From a fact that an incoming direction of a radio wave output from the transmitting apparatus 200 is gradually widened, and from the change in the movement direction at the position x1, the autonomous moving apparatus 100 moving in a direction of the path K2 can recognize the presence of the obstacle J1 and can estimate the path K3. Therefore, the autonomous moving apparatus 100 can change a traveling direction toward the transmitting apparatus 200 at a position x2 and can reach the transmitting apparatus 200.

### (Outline of Echolocation)

Next, with reference to FIG. 2, a description will be given regarding a mechanism (echolocation) in which the autonomous moving apparatus 100 reaches a target object P1 while selecting a suitable travel path which is less affected by obstacles p1 to p4. FIG. 2 is an explanatory diagram showing a situation in which the autonomous moving apparatus 100 travels on a planar travel path where the plurality of obstacles p1 to p4 are present, and travels toward a destination P1.

When the autonomous moving apparatus 100 autonomously travels from a position P0 to the destination P1, the obstacle p2 is present on a travel path x0 which is the shortest path. In this case, the autonomous moving apparatus 100 outputs an acoustic wave in the traveling direction and receives the acoustic wave reflected by a surface of the obstacle p2. The autonomous moving apparatus 100 detects the obstacle p2 from the received acoustic wave, and changes the movement direction at a position P2 which is closer to the autonomous moving apparatus 100 than the obstacle p2 to avoid collision with the obstacle p2.

At this time, it is desirable that the autonomous moving apparatus 100 changes the movement direction to a left direction to avoid the obstacle p2. That is, a travel path x1 on the left side of the obstacle p2 as viewed from the autonomous moving apparatus 100 is an open space. Therefore, the autonomous moving apparatus 100 can travel without being regulated by the obstacle. However, a travel path x2 on the right side of the obstacle p2 extends in a complicated space. Therefore, when the autonomous moving apparatus 100 travels, the autonomous moving apparatus 100 is more regulated by the obstacle. Therefore, it is preferable to change the movement direction of the autonomous moving apparatus 100 to the left direction.

Meanwhile, the travel path x2 on the right side of the obstacle p2 extends in the complicated space, and when the autonomous moving apparatus 100 travels, the autonomous moving apparatus 100 is more regulated by the obstacle. More specifically, there are following problems. a) When there are obstacles in the immediate vicinity of an antenna, the phase shift occurs, and the accuracy of direction detection remarkably deteriorates. Further, b) when the autonomous moving apparatus 100 enters a complicated space with many obstacles, the reflection of a radio wave becomes complicated and the autonomous moving apparatus is not able to escape from the space.

The autonomous moving apparatus 100 receives sound reflected by peripheral objects (obstacles p1 to p4) using a pair of left and right microphones. By comparing left and right sound signals, it is possible for the autonomous moving apparatus 100 to avoid an intricate and complicated space with many obstacles p1 to p4, and travel in an open space without being regulated by peripheral objects to reach the destination P1. More specific methods will be described later.

### (Details of Autonomous Moving Apparatus)

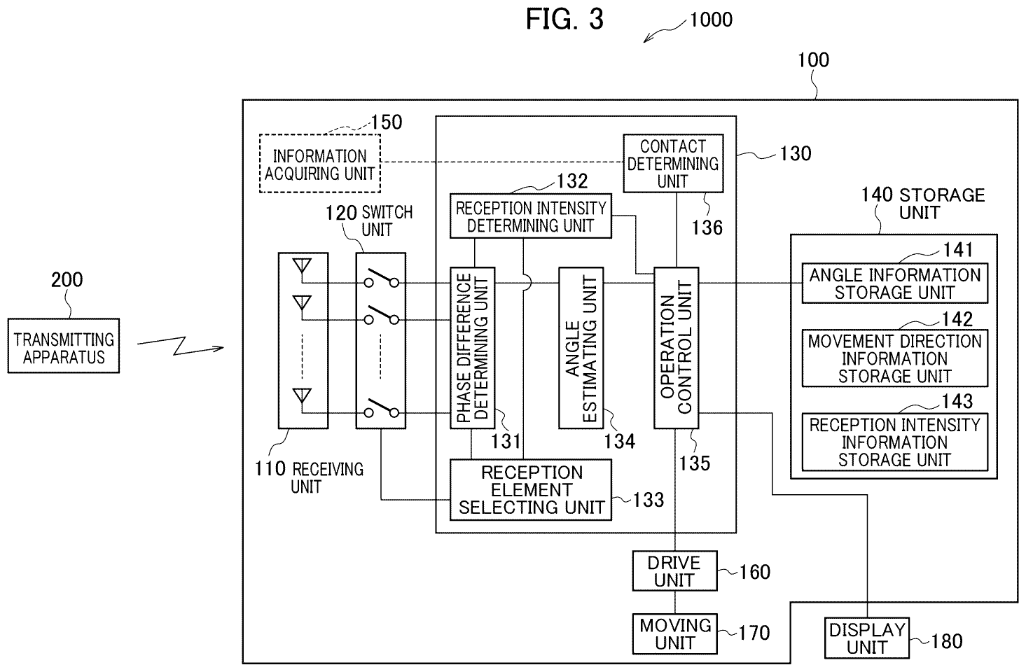

With reference to FIG. 3, the detailed configuration of the autonomous moving apparatus 100 according to the plurality of embodiments will be described. The autonomous moving apparatus 100 includes a receiving unit 110 with a plurality of antennas, a switch unit 120 for selecting reception elements of the receiving unit 110, a control unit 130, a storage unit 140, an information acquiring unit 150, a drive unit 160, and a moving unit 170. The autonomous moving apparatus 100 may also include a display unit 180. In addition, basically the moving unit 170 such as a wheel, a belt, a caterpillar, or a propeller is driven by means of drive information output from the drive unit 160 shown in FIG. 3, so that the autonomous moving apparatus 100 moves. The receiving unit 110 has a plurality of reception elements.

The receiving unit 110 is an antenna which receives a radio wave (including high-frequency electromagnetic wave) output from the transmitting apparatus 200. The receiving unit 110 may be an array antenna constituted by a plurality of antenna elements, for example. If the receiving unit 110 is the array antenna, an array of the antenna elements constituting the array antenna may be an arbitrary array. The antenna elements may be arranged in a line in the traveling direction of the autonomous moving apparatus 100 or in a direction intersecting the traveling direction such as a direction orthogonal to the traveling direction, for example. It is also possible to arrange the antenna elements so as to form a rectangular shape or an annular shape on a plane not intersecting the traveling direction or on a plane intersecting the traveling direction of the autonomous moving apparatus 100. Further, it is also possible to array the antenna elements in a curved shape. Still further, it is not necessary that the number of the array antenna is one, but the number of array antennas arranged may be more than one to enhance the accuracy of estimation of an incoming direction of a radio wave and the like. In addition, the receiving unit 110 may be constituted by a plurality of antennas having directivities in different directions. In this case, the plurality of antennas may be arranged in the same manner as the antenna elements of the array antenna. In addition, partition plates made of metal or the like may be disposed to at least one non-directional antenna so as to be able to detect the intensity of a radio wave or a high-frequency electromagnetic wave in a direction surrounded by the partition plates.

The switch unit 120 is a switch configured to select any one of reception elements of the receiving unit 110 and output information on a radio wave or the like received by the reception element. Therefore, the number of switches of the switch unit 120 is equal to the number of the reception elements of the receiving unit 110, and one switch may correspond to one reception element. If the receiving unit 110 is the array antenna, a plurality of antenna elements are selected, and information on the intensity and phase of radio waves received by the plurality of antenna elements is output to a phase difference determining unit 131 and a reception intensity determining unit 132, which will be described later, for example. Further, the switch unit 120 is preferably, but is not limited to, a semiconductor switch, and it is possible to employ a switch which can open and close an electrical connection of any configuration.

The control unit 130 can be implemented using a microcomputer having a Central Processing Unit (CPU) or the like. A computer program (autonomous movement program) for causing the microcomputer to function as the control unit 130 is installed in the microcomputer and is executed. As a result, the microcomputer functions as a plurality of information processing units of the control unit 130.

The control unit 130 includes, as the plurality of information processing units, the phase difference determining unit 131, the reception intensity determining unit 132, a reception element selecting unit 133, an angle estimating unit 134, an operation control unit 135, and a contact determining unit 136.

The phase difference determining unit 131 analyzes received signals from the plurality of reception elements of the receiving unit 110 selected by the reception element selecting unit 133, and determines phase differences between the received signals from the differences in arrival times between the received signals. The determined phase differences are output to the angle estimating unit 134. Further, if the autonomous moving apparatus 100 stops or moves, the phase difference determining unit 131 can also determine one angle from the plurality of phase differences between the plurality of received signals.

The reception intensity determining unit 132 determines the reception intensity from the plurality of reception elements of the receiving unit 110 selected by the reception element selecting unit 133. The estimated reception intensity is output to the operation control unit 135. Further, the estimated reception intensity may be output to the reception element selecting unit 133. The reception intensity may be expressed in an arbitrary unit related to the reception intensity, and may be expressed as relative information. The reception intensity may be output to the operation control unit 135 and the reception element selecting unit 133 as reception intensity information in any format.

The reception element selecting unit 133 selects elements for receiving radio waves and the like from the plurality of reception elements of the receiving unit 110. It is preferable that the number of reception elements selected is one or more. In order that the phase difference determining unit 131 determines the phase difference, the reception element selecting unit 133 selects a plurality of reception elements. Further, it is possible that the reception element selecting unit 133 selects the reception elements in order, and selects one or more reception elements in which the reception intensity is determined to be high by the reception intensity determining unit 132, and the angle estimating unit 134 estimates an incoming direction of a radio wave and the like via the phase difference determining unit 131.

The angle estimating unit 134 can adopt any incoming direction estimation method, such as an estimation method in which a complex reception response to an incoming wave is obtained in advance from the phase difference of several sets of antenna elements, an evaluation function is introduced, and an angle at which an evaluation function value is maximum is set as an incoming direction of a radio wave. Further, the angle estimating unit 134 can estimate an incoming direction of a radio wave from the phase difference of a plurality of antenna elements. A Multiple Signal Classification (MUSIC) and Root-MUSIC method using eigenvalues and eigenvectors of a correlation matrix can be adopted, for example. Further, an Estimation of Signal Parameters via Rotational Invariance Techniques (ESPRIT) method can be adopted. The angle estimated in this way is stored in an angle information storage unit 141 of the storage unit 140 as arbitrary angle information from a reference axis. Still further, the estimated angle information may be stored in the angle information storage unit 141 in association with the reception intensity determined by the reception intensity determining unit 132. Furthermore, the estimated angle information may also be stored in the angle information storage unit 141 in association with the determined reception intensity and time information. The time information may be received by the receiving unit 110 from the outside of the autonomous moving apparatus 100, and the autonomous moving apparatus 100 can perform timing using a timing unit (not shown).

In addition, there may be a plurality of angles estimated by the angle estimating unit 134. If there are a plurality of angles estimated, it is also possible that the angle estimating unit 134 receives the reception intensity at each angle from the reception intensity determining unit 132, associates each angle with the reception intensity, and stores the information in the angle estimating unit 134. If there is an obstacle, a radio wave reflected by the obstacle and a radio wave propagated on a line-of-sight may be received by the autonomous moving apparatus 100 at different angles, for example. In addition, the radio wave reflected by the obstacle may be further reflected by another obstacle and received by the autonomous moving apparatus 100 at a further different angle. In this way, the reflected wave from the obstacle may reach the autonomous moving apparatus 100 after being reflected multiple times. Basically, the autonomous moving apparatus 100 moves in a direction where the reception intensity is high. However, there is a possibility that an obstacle prevents the autonomous moving apparatus from moving in the direction where the reception intensity is high, or that a path is wrong. In this way, there is also a possibility that the autonomous moving apparatus 100 may not avoid moving in a direction of another reflected wave. Therefore, if a plurality of angles are estimated, the autonomous moving apparatus 100 can associate each angle with the reception intensity and store the information in the angle information storage unit 141.

The operation control unit 135 generates movement direction information including a movement direction for moving the autonomous moving apparatus 100 in response to the magnitude or change of the reception intensity determined by the reception intensity determining unit 132 and an incoming direction of a radio wave estimated by the angle estimating unit 134. In the embodiments, suppose that the operation control unit 135 determines that there is an obstacle or a complicated space in the periphery of the autonomous moving apparatus 100 based on information from the information acquiring unit 150, which will be described later, for example. In the above case, the operation control unit 135 generates movement direction information, assuming that the reliability of an estimation result by the angle estimating unit 134 and/or a determination result by the reception intensity determining unit 132 is lower than a predetermined reference value. That is, basically, when a reliability index (1) is lower than the predetermined reference value, the operation control unit 135 performs movement control so as to avoid the vicinity thereof.

The operation control unit 135 may generate movement direction information by performing weighting on an estimated incoming direction of a radio waves according to the reliability. More specifically, the operation control unit 135 may multiply the reception intensity (R) of a plurality of estimated incoming directions of radio waves by the degree of reliability (reliability degree: I) to obtain a product (R*I), and may control the autonomous moving apparatus to move in an incoming direction where the product (R*I) is large. A case is not limited to a case where a plurality of incoming directions of radio waves can be estimated at the same time, but a plurality of incoming directions of radio waves may be compared in the past history. That is, the operation control unit 135 may generate movement direction information by weighting an incoming direction of a radio wave stored in the storage unit 140 by an index according to the reliability. In addition, if the reliability deteriorates, the operation control unit 135 may control the autonomous moving apparatus to move in a space or direction where the reliability is high.

There are various methods for a method in which the operation control unit 135 determines that the reliability is low due to the presence of an obstacle or a complicated space in the periphery of the autonomous moving apparatus 100. The operation control unit 135 may determine the reliability based on at least one of the magnitude, the change, the number of reception times, the left-right comparison, and the comparison with the past history of received output information, as well as an estimated distance to an obstacle, the shape of a space, the reception intensity, the amount of noise, and the stability of an incoming direction angle, for example. If the reception intensity determined by the reception intensity determining unit 132 oscillates periodically in an estimated direction, the operation control unit 135 may determine that an obstacle is present in the estimated direction and lower the reliability, for example. This is because, when the reception intensity oscillates periodically, there is a possibility an obstacle is present in the periphery of the autonomous moving apparatus 100 or between the autonomous moving apparatus 100 and a target object, and a diffracted wave is received.

In addition, in order for the operation control unit 135 to determine a peripheral obstacle or an intricate and complicated space, the autonomous moving apparatus 100 may include an obstacle measuring unit for measuring a distance to an obstacle. In the preset embodiment, units from the information acquiring unit 150 to the contact determining unit 136, which will be described later, function as obstacle measuring units. The information acquiring unit 150 may be an infrared sensor, an ultrasonic sensor, or a depth sensor. Further, when the operation control unit 135 receives contact prediction information or contact information from the contact determining unit 136, the operation control unit 135 can determine that the reliability is low and change a movement direction so as to avoid the obstacle or intricate complicated space. In this case, the changed direction may be maintained temporarily or for a predetermined period of time.

In this way, the operation control unit 135 can associate an index according to the reliability, an incoming direction and the reception intensity of a radio wave, and the history of control contents of the autonomous moving apparatus 100 and store the information in the storage unit 140. The operation control unit 135 can generate movement direction information in consideration of the time transition of the histories. The operation control unit 135 can associate a movement direction, a movement time or a movement distance in the movement direction, reliability, and the like and store the information in a movement direction information storage unit 142. As described above, from the above described information stored in the movement direction information storage unit 142, the operation control unit 135 can calculate the past movement history and generate map information. This enables the autonomous moving apparatus to move by avoiding the periphery of an obstacle or a complicated space with low reliability.

Further, if the radio wave intensity is very low, and if an incoming direction of a radio wave may not be estimated by the angle estimating unit 134, the autonomous moving apparatus including the operation control unit 135 may move while maintaining the current movement direction. This is because if a null point occurs due to interference between an emitted radio wave and a reflected radio wave, it may be possible to estimate an incoming direction of a radio wave again by the autonomous moving apparatus 100 moving to another point, for example.

Further, the operation control unit 135 can perform machine learning or deep learning using information such as movement history information, angle information, information on an estimated direction of a radio wave, and reliability, and store machine learning result information or deep learning result information in the storage unit 140. Therefore, the operation control unit 135 causes the storage unit 140 to store the reliability history according to the reliability and movement direction information as teaching data. Still further, the machine learning result information or deep learning result information can be stored in the storage unit 140 in association with the information such as the movement direction information, angle information, information on an estimated direction of a radio wave, and reliability.

The contact determining unit 136 determines whether there is a possibility that the autonomous moving apparatus 100 contacts an obstacle, based on information acquired by the information acquiring unit 150. After the information acquiring unit 150 detects the obstacle, the information acquiring unit 150 transmits information on the detected obstacle to the contact determining unit 136. The contact determining unit 136 transmits contact prediction information to the operation control unit 135, if the contact determining unit 136 expects that the autonomous moving apparatus 100 contacts the obstacle, based on a movement direction and size of the autonomous moving apparatus 100 and the obtained information on the obstacle. Further, the contact determining unit 136 transmits contact information to the operation control unit 135, if the contact determining unit 136 determines that the autonomous moving apparatus 100 contacts the obstacle.

The storage unit 140 is a computer-readable storage medium. The storage unit 140 may be a Read Only Memory (ROM) or an Erasable Programmable ROM (EPROM), for example. Further, the storage unit 140 may be an Electrically Erasable Programmable ROM (EEPROM), a Random Access Memory (RAM), a hard disk, or the like.

The storage unit 140 includes the angle information storage unit 141, the movement direction information storage unit 142, and a reception intensity information storage unit 143.

The angle information storage unit 141 stores angle information of a radio wave of which an incoming direction is estimated by the angle estimating unit 134. The angle information may be information from a predetermined reference axis, which may be based on a physical outline of the autonomous moving apparatus 100. The outline may be expressed in two-dimensional relative coordinates other than a space in which the autonomous moving apparatus 100 moves, and a line represented by the relative coordinates may be used as the reference axis, for example. The angle information may be stored in association with estimated radio wave reception intensity information and time information at which the angle information is estimated. This is because, in the predetermined case described above, angle information other than angle information in which the reception intensity is the highest may be used, and it may be necessary to compare the information with the past angle information. In addition, the angle information may represent an angle changed from a first determined angle and may be stored in such a way that it is easy to create map information.

The movement direction information storage unit 142 can store information on a movement direction which is determined by the operation control unit 135 and in which the autonomous moving apparatus 100 actually moves, in association with time information at which movement of the autonomous moving apparatus in the movement direction starts, and time information at which the movement of the autonomous moving apparatus in the movement direction ends. In addition, the time information at which the movement of the autonomous moving apparatus in the movement direction starts, or the time information at which the movement of the autonomous moving apparatus in the movement direction ends, and timing information at which the autonomous moving apparatus is moving in the movement direction may be stored in the movement direction information storage unit 142, in association with the movement direction information. The operation control unit 135 may reproduce the past movement path of the autonomous moving apparatus 100 based on the pieces of information. In order that the autonomous moving apparatus may reach a target object, the operation control unit 135 can select a path which prevents the autonomous moving apparatus from travelling along the same movement path, with reference to the past movement path. Further, the contact determining unit 136 may also estimate a position of an obstacle with reference to the past movement path. In addition, the control unit 130 may perform machine learning or deep learning, and the storage unit 140 including the movement direction information storage unit 142 may store machine learning result information or deep learning result information. Further, the machine learning result information or deep learning result information may be stored in association with the information such as the movement direction information, angle information, information on an estimated direction of a radio wave, and reliability.

The reception intensity information storage unit 143 stores reception intensity information of radio waves received by a plurality of reception elements, the information being determined by the reception intensity determining unit 132. Further, the reception intensity information storage unit 143 stores the reception intensity of the radio waves from the plurality of reception elements in an estimated radio wave incoming direction. Still further, the reception intensity information may be stored in the reception intensity information storage unit 143 in association with time information at which the reception intensity is determined.

The drive unit 160 includes a mechanism for driving the moving unit 170 to move the autonomous moving apparatus 100 in a movement direction determined by the operation control unit 135. The drive unit 160 includes a mechanism for rotating a wheel if the moving unit 170 is the wheel, a mechanism for turning a caterpillar if the moving unit 170 is the caterpillar, and a mechanism for rotating a propeller if the moving unit 170 is the propeller, for example. The drive unit 160 is not limited to the above aspects, but the drive unit can have any driving configuration that drives a configuration of the moving unit 170.

The moving unit 170 is a portion constituting means for moving the autonomous moving apparatus 100. If the autonomous moving apparatus 100 is a vehicle, the moving unit 170 may be a wheel including a tire, a caterpillar, or the like. Further, if the autonomous moving apparatus 100 is a flying object such as a drone or a helicopter, the moving unit 170 may be a propeller. The moving unit 170 is not limited to the above aspects, but the moving unit can have any moving mechanism capable of moving the autonomous moving apparatus 100.

The display unit 180 can optionally be attached to the autonomous moving apparatus 100, or installed in a monitor space separated from the autonomous moving apparatus 100 to enable a user to confirm image information in a movement direction of the autonomous moving apparatus 100. As described above, it is also possible for the user to confirm whether the autonomous moving apparatus 100 is moving normally by confirming the image information output to the display unit 180.

The transmitting apparatus 200 shown in FIG. 1 can be arranged in the periphery of a target object or attached to the target object. Further, the transmitting apparatus 200 may be the target object. Information output by the transmitting apparatus 200 needs to be information that can be received by the receiving unit 110 of the autonomous moving apparatus 100. Examples of the information output by the transmitting apparatus 200 include, but are not limited to, radio waves and high-frequency electromagnetic waves, as described above, but may also include electromagnetic waves, vibration waves, and the like of any frequency. Still further, it is not necessary that the frequency of radio waves, vibration waves, and the like is fixed, and the frequency can be changed periodically or randomly. In addition, the transmitting apparatus 200 may be configured to repeatedly sweep the frequency in a predetermined frequency range. The frequency fluctuation may make it easier for the autonomous moving apparatus 100 to determine the presence of an obstacle, even if the autonomous moving apparatus 100 does not include the information acquiring unit 150. In addition, the transmitting apparatus 200 may be an electronic device used by the user such as a mobile phone, PHS telephone, smartphone, or personal digital assistant carried by the user, or another autonomous moving apparatus.

The autonomous moving apparatus 100 according to the embodiments may further include a transmitting unit (not shown) that transmits, to the outside, arrival information to the target object or abnormality information during movement in a wired or wireless manner. The transmitting unit can wirelessly transmit the arrival information and abnormality information to an external electronic device by means of what is referred to as mobile communication. Further, the transmitting unit may perform wireless communication which is based on a near-field communication standard of at least one of wireless LAN and Bluetooth (registered trademark). Still further, the transmitting unit may communicate with the outside by means of connection using a cable (for example, USB cable, optical cable). According to this kind of a configuration, it is possible for another device to perform the following processing in response to reception of the arrival information or abnormality information.

A transmission destination of the transmitting unit may be an electronic device used by the user such as a computer arranged on the cloud, or a mobile phone, PHS telephone, smartphone, or personal digital assistant carried by the user, for example.

### (Details of Echolocation)

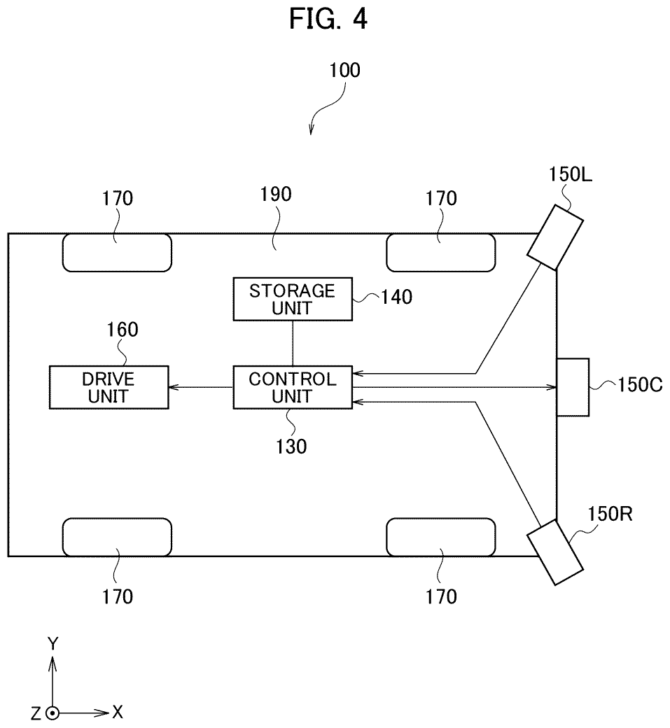

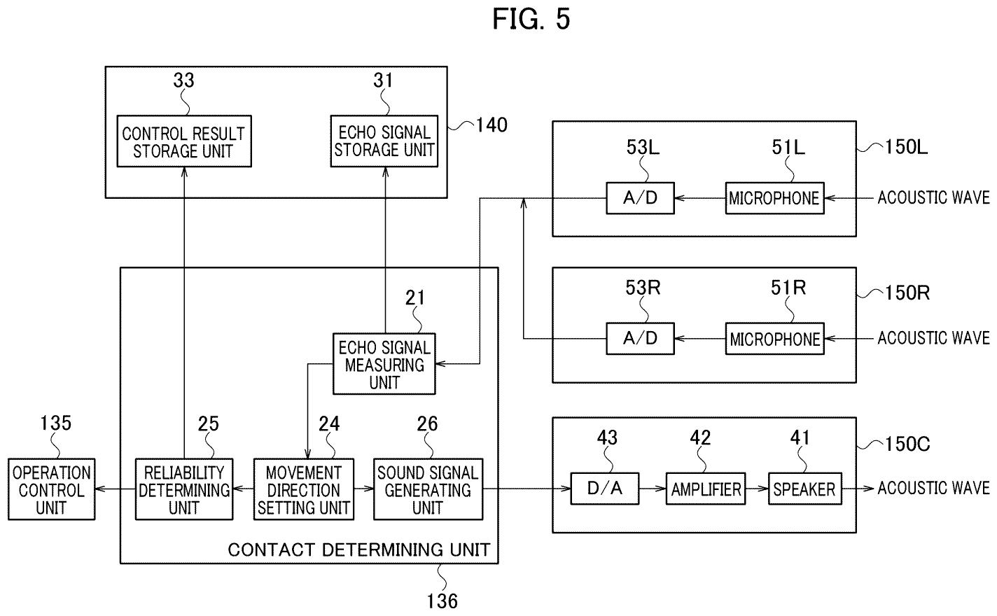

The information acquiring unit 150 may be a device having one or more speakers and two or more microphones. As an example, a device having one speaker and two microphones will be described with reference to FIG. 4. FIG. 4 is a block diagram showing an example of an echolocation configuration of one speaker and two microphones in the autonomous moving apparatus 100 according to the present embodiment. FIG. 5 is a block diagram showing details of each component in the echolocation configuration shown in FIG. 4.

As shown in FIG. 4, the autonomous moving apparatus 100 includes the control unit 130, the storage unit 140, the drive unit 160, four wheels as the moving unit 170, and one sound transmitting unit 150C and two sound receiving units 150L and 150R as the form of the information acquiring unit 150.

The sound transmitting unit 150C is attached to a vehicle body 190 of the autonomous moving apparatus 100, and transmits an acoustic wave toward an area including a front direction of the vehicle body 190 (positive direction of X axis). As shown in FIG. 5, the sound transmitting unit 150C includes a speaker 41, an amplifier 42, and a D/A conversion unit 43. With reference to FIGS. 4 and 5, an example of the autonomous moving apparatus having one sound transmitting unit 150C is described, but as will be described later, the autonomous moving apparatus may have a plurality of sound transmitting units 150C. If sound emitted from the sound transmitting unit 150C does not reach the entire periphery of the autonomous moving apparatus 100, two sound transmitting units 150C may be disposed on the left and right sides of the autonomous moving apparatus 100, for example.

The sound transmitting unit 150C outputs an ultrasonic wave or an acoustic wave of a frequency in a human audible band. The sound transmitting unit 150C may be configured to output an acoustic wave other than an ultrasonic wave or an acoustic wave of a frequency in an audible band. The term “acoustic wave” is a general term for an elastic wave that propagates regardless of gas, liquid, or solid.

The sound transmitting unit 150C outputs an acoustic wave at predetermined intervals or at irregular intervals. The sound transmitting unit 150C also has a function of changing a frequency of an acoustic wave to be transmitted. That is, when a frequency of an acoustic wave generated by a sound signal generating unit 26 described later is changed, the acoustic wave of the changed frequency is transmitted. When the autonomous moving apparatus has a plurality of sound transmitting units 150C, timings at which the sound transmitting units 150C output acoustic waves can be synchronized.

The D/A conversion unit 43 converts a digital sound signal generated by the control unit 130, which will be described later, into an analog signal. The sound includes a human audible frequency sound, an ultrasonic wave sound higher than the audible frequency, and ultra-low frequency sound lower than the audible frequency. The sound is an example of an acoustic wave.

The amplifier 42 amplifies the analog sound signal which has been converted from the digital sound signal. When an ultrasonic speaker is used as the speaker 41, a rectangular wave of a digital output can be output without any changes. That is, a logic output may be used instead of an analog output, and a buffer circuit may be disposed instead of the D/A conversion unit 43 and amplifier 42.

The speaker 41 outputs the analog sound signal amplified by the amplifier 42 as an acoustic wave. The speaker 41 is disposed so as to face a straight-travelling direction of the autonomous moving apparatus 100, and outputs an acoustic wave toward the straight-travelling direction of the autonomous moving apparatus 100, for example. In other words, the sound transmitting unit 150C outputs an acoustic wave toward one direction that serves as a reference of the autonomous moving apparatus 100 (for example, straight-travelling direction). It is sufficient if the straight-travelling direction of the autonomous moving apparatus 100 is included in a range where the speaker 41 outputs the acoustic wave. A center axis of the speaker 41 may be different from the straight-travelling direction of the autonomous moving apparatus 100 (front direction). Hereinafter, the “straight-travelling direction” may be referred to as a “front direction”.

The sound receiving unit 150L and the sound receiving unit 150R are attached to the vehicle body 190 of the autonomous moving apparatus 100, receive acoustic waves reflected by objects in the periphery of the autonomous moving apparatus 100, and convert the acoustic waves into electric signals. The sound receiving unit 150L (acoustic wave receiving unit) is disposed on the left side from the front direction of the autonomous moving apparatus 100. The sound receiving unit 150R (acoustic wave receiving unit) is disposed on the right side from the front direction of the autonomous moving apparatus 100. In other words, two sound receiving units are symmetrically arranged relative to one direction that serves as a reference of the autonomous moving apparatus 100 (for example, front direction).

One sound receiving unit 150L receives an acoustic wave on the left side relative to the front direction of the autonomous moving apparatus 100. The other sound receiving unit 150R receives an acoustic wave on the right side relative to the front direction of the autonomous moving apparatus 100. The two sound receiving units 150L and 150R are a plurality of acoustic wave receiving units of which acoustic wave input directions are different from each other. The sound receiving units 150L and 150R include microphones 51L and 51R and A/D conversion units 53L and 53R, respectively.

The microphones 51L and 51R receive acoustic waves reflected by objects and convert the acoustic waves into sound signals as electric signals. The microphone 51L on the left side is disposed so as to face a left direction by 30 degrees, relative to the front direction of the autonomous moving apparatus 100, for example. The microphone 51R on the right side is disposed so as to face a right direction by 30 degrees, relative to the front direction of the autonomous moving apparatus 100, for example.

The microphones 51L and 51R may be arranged with the speaker 41 therebetween in a left-right direction perpendicular to the front direction of the autonomous moving apparatus 100. In other words, the speaker 41 may be interposed between the microphones 51L and 51R in a vehicle width direction. The orientations of the microphones 51L and 51R are not limited to the angles as long as the microphones are disposed between the front direction of the autonomous moving apparatus 100 and the left-right direction. The two microphones 51L and 51R may face different directions. If the autonomous moving apparatus 100 is a drone and moves in a three-dimensional space, sound receiving units may be disposed at four positions, that are a left position, a right position, a top position, and a bottom position of the autonomous moving apparatus 100. In this case, microphones may be disposed at four positions, that are a top position, a bottom position, a left position, and a right position on the front side of the autonomous moving apparatus 100.

The A/D conversion units 53L and 53R convert analog sound signals output from the microphones 51L and 51R into digital signals and output the digital signals to the control unit 130.

The storage unit 140 may include an echo signal storage unit 31 and a control result storage unit 33.

The echo signal storage unit 31 stores an echo signal measured by an echo signal measuring unit 21, which will be described later. Here, the term “echo signal” indicates a phenomenon in which sound is reflected by a certain target plane and is heard again. The term “echo signal” is a concept including “reverberation” which indicates a phenomenon in which even after a sound source stops vibrating, the reflection from a ceiling or a wall is repeated, and the sound is continuously heard.

The control result storage unit 33 stores a control result by a reliability determining unit 25, which will be described later.

The contact determining unit 136 includes the echo signal measuring unit 21, a movement direction setting unit 24, the reliability determining unit 25, and the sound signal generating unit 26.

The sound signal generating unit 26 generates a sound signal of a predetermined frequency, and outputs the generated sound signal to the sound transmitting unit 150C at a predetermined time interval (for example, one second interval).

The sound signal generating unit 26 changes a frequency of a sound signal as necessary. Suppose that, in addition to the autonomous moving apparatus 100, another moving apparatus transmits a sound signal, and a frequency of the sound signal approximates or matches a frequency of a sound signal transmitted by the sound transmitting unit 150C of the autonomous moving apparatus 100, for example. In the above case, the frequency of the sound signal transmitted from the sound transmitting unit 150C is changed such that the frequency is different from the frequency of the sound signal transmitted from another moving apparatus.

The echo signal measuring unit 21 receives sound signals output from the A/D conversion units 53L and 53R and transfers the sound signals to the echo signal storage unit 31 and the movement direction setting unit 24 individually.

When an obstacle is present in a travelling direction of the autonomous moving apparatus 100, the movement direction setting unit 24 analyzes a sound signal transferred from the echo signal measuring unit 21 and pieces of data stored in the echo signal storage unit 31 and the control result storage unit 33, and sets a movement direction of the autonomous moving apparatus 100. Further, the movement direction setting unit 24 calculates travel information such as a turning direction, turning angle, and traveling speed of the autonomous moving apparatus 100. When there are a plurality of incoming directions of output information, the movement direction setting unit 24 does not set a travelling direction, but provides various pieces of information such as the plurality of incoming directions to the reliability determining unit 25.

The reliability determining unit 25 determines the reliability degree based on the various pieces of information obtained from the movement direction setting unit 24, and outputs various drive signals such as the reliability degree to the operation control unit 135. The drive signals include information related to driving such as a movement direction, turning direction, turning angle, and travelling speed, in addition to the reliability degree.

The reliability determining unit 25 outputs a control signal output to the drive unit 160 to the control result storage unit 33. The control result storage unit 33 stores the control signal output from the reliability determining unit 25.

Next, a description will be given regarding a setting method of a movement direction by the movement direction setting unit 24, when the autonomous moving apparatus 100 avoids an obstacle.

### (First Setting Method)

The movement direction setting unit 24 sets a movement direction of the autonomous moving apparatus 100 based on a received echo signal. The movement direction setting unit 24 outputs information on the set movement direction to the reliability determining unit 25.

Suppose that, when the autonomous moving apparatus 100 autonomously travels from the position P0 to the destination P1 shown in FIG. 2, the obstacle p2 is present on the travel path x0 which is the shortest path, for example. In the above case, the autonomous moving apparatus 100 changes a movement direction at the position P2 which is closer to the autonomous moving apparatus 100 than the obstacle p2 to avoid the obstacle p2. At this time, the travel path x2 on the right side of the obstacle p2 extends in an intricate and complicated space, and when the autonomous moving apparatus travels, the autonomous moving apparatus is more regulated by obstacles. Therefore, it is preferable to change the movement direction of the autonomous moving apparatus 100 to a left direction. Therefore, the contact determining unit 136 shown in FIG. 5 determines a peripheral obstacle and complicated space to calculate the reliability degree, and provides a drive signal including the reliability degree to the operation control unit 135.

### (Second Setting Method)

The movement direction setting unit 24 acquires an echo signal received in the past which is stored in the echo signal storage unit 31 and the past control signal stored in the control result storage unit 33.

The movement direction setting unit 24 performs machine learning based on the past control signal output by the reliability determining unit 25 using the sound receiving units 150L and 150R on left and right sides. By performing machine learning, the movement direction setting unit 24 acquires a correlation between an echo signal and a movement direction when the autonomous moving apparatus 100 avoids an obstacle. The machine learning is a well-known technology, and therefore a detailed description thereof will be omitted.

The movement direction setting unit 24 sets an optimum movement direction of the autonomous moving apparatus 100 based on the acquired correlation, and the reliability determining unit 25 determines the reliability degree based on a machine learning result.

The reliability determining unit 25 sets travel information such as a movement direction, turning direction, turning angle, and travelling speed of the autonomous moving apparatus 100 using a machine learning result based on the past control result, and outputs a drive command to the drive unit 160 together with the reliability degree. As a result, when the autonomous moving apparatus 100 travels by avoiding an obstacle, the autonomous moving apparatus 100 can travel by selecting a more open travel path.

According to the above configuration, in the autonomous moving apparatus 100 such as an unmanned transport vehicle, SLAM eliminates the necessity of expensive equipment such as a camera or LiDAR, and the manufacturing cost can be reduced by adopting a simple configuration. Further, when the autonomous moving apparatus 100 is introduced to a new location, and each time a layout of a previous location is changed, it is not necessary to create a map of the location or layout, and this can also reduce the introduction cost. It is also not necessary to determine a plan of a travel path in advance. It is not necessary to lay a magnetic tape, a magnetic rod, or a two-dimensional cord on the floor for guiding a vehicle such as an Automatic Guided Vehicle (AGV). Further, it is not necessary to perform computational processing of a large amount of data which is required by a robot such as an Autonomous Mobile Robot (AMR), and an expensive computer associated with this becomes unnecessary. This can also reduce the power consumption.

The autonomous moving apparatus 100 may also have a short distance measuring sensor, a depth camera, or a stereo camera for preventing contact with an obstacle that appears in the immediate vicinity (for example, within 50 cm), and a bumper sensor or a contact sensor for detecting collision with an obstacle. When the autonomous moving apparatus 100 is applied to an unmanned transport vehicle, it is needless to say that the autonomous moving apparatus 100 has a function that satisfies the provision related to ISO3691-4/JIS D 6802 “Automatic guided vehicles and systems-Safety requirements and verification” related to the safety of an unmanned transport vehicle.

### (Embodiment of Speaker and Microphone)

As described above, there are various embodiments for the number of speakers and microphones for echolocation, orientations of a speaker and a microphone relative to the vehicle body 190, and a layout on the vehicle body 190. Further, as another embodiment for a speaker and a microphone, there is a composite unit for the autonomous moving apparatus 100 in which microphones and a speaker are arranged in one casing (package). The composite unit of a speaker-microphone as one component of the autonomous moving apparatus 100 is fixed on the vehicle body 190 of the autonomous moving apparatus 100, and wiring such as a signal line and a power line is used to electrically connect between the composite unit and another component such as the control unit 130, the storage unit 140, or the drive unit 160 of the autonomous moving apparatus 100. As a result, the autonomous moving apparatus 100 can be manufactured using the composite unit of a speaker-microphone as a component. The autonomous moving apparatus 100 and a composite unit 300 of a speaker-microphone will be described below as embodiments of a speaker and a microphone for echolocation. Other configurations of the autonomous moving apparatus 100 except for speakers and microphones in the following embodiments are the same as those of the autonomous moving apparatus 100 already described with reference to FIGS. 3 and 5, and therefore duplicated descriptions thereof will be omitted.

### First Embodiment

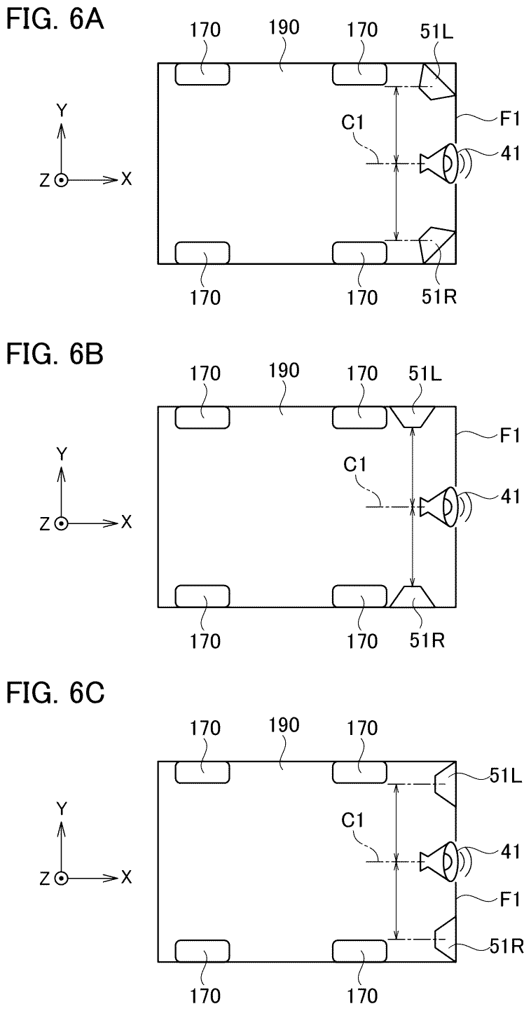

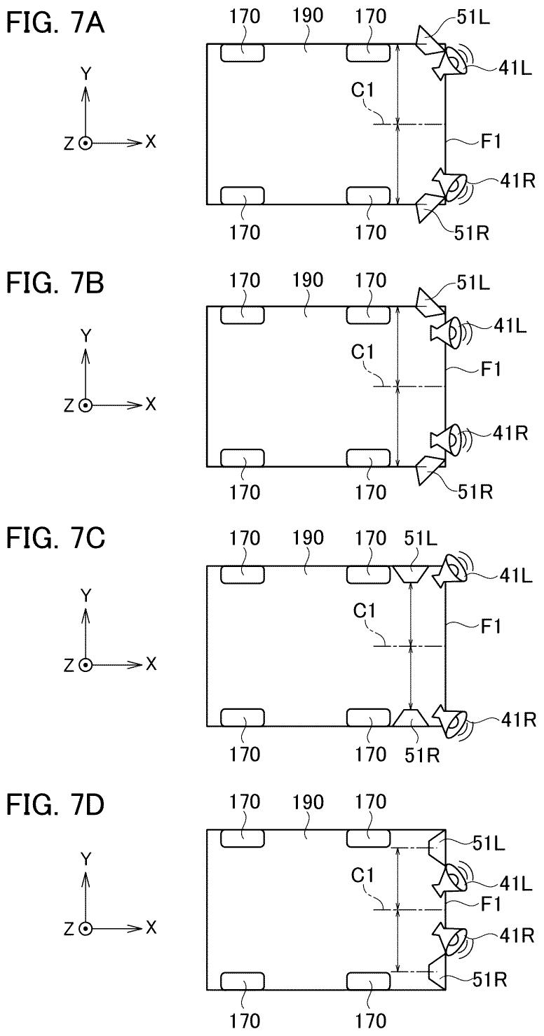

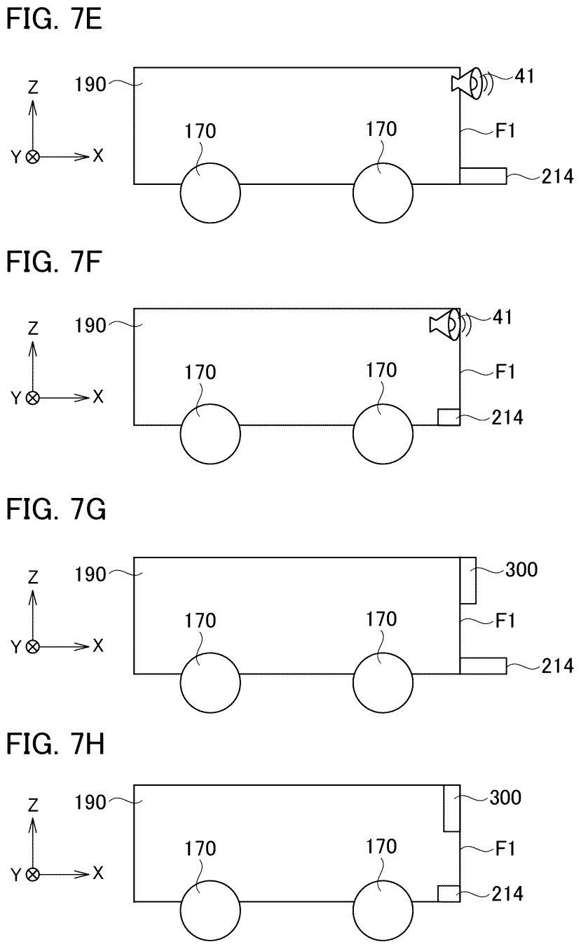

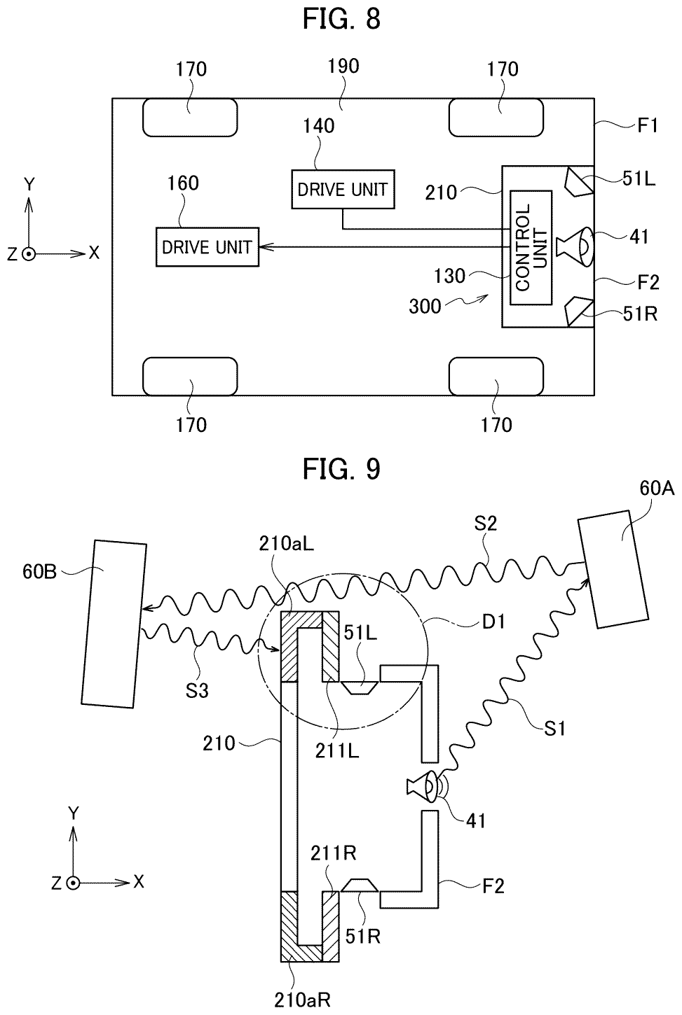

In a first embodiment, with reference to FIGS. 6A to 7D and 8, a description will be given regarding layouts of a speaker and microphones for increasing the difference in sound pressures of acoustic waves received by the pair of left and right microphones 51L and 51R. FIGS. 6A to 7D show an embodiment of the autonomous moving apparatus 100, and FIG. 8 shows an embodiment of the composite unit 300 of a speaker-microphone for the autonomous moving apparatus.

As shown in FIGS. 6A to 6C, the autonomous moving apparatus 100 includes the vehicle body 190, a first speaker 41 which is attached to the vehicle body 190 and transmits an acoustic wave toward an area including the front direction of the vehicle body 190 (positive direction of X axis), and a first microphone 51L and a second microphone 51R which are attached to the vehicle body 190, receive acoustic waves reflected by objects in the periphery of the autonomous moving apparatus 100, and convert the acoustic waves into electric signals. The first speaker 41 corresponds to the speaker 41 shown in FIG. 5. The first microphone 51L and the second microphone 51R correspond to the microphone 51L and the microphone 51R shown in FIG. 5, respectively. A vehicle having four wheels is exemplified as the moving unit 170. It is sufficient if the front direction of the autonomous moving apparatus 100 (positive direction of X axis) is included in the area to which the acoustic wave is output by the first speaker 41, and a center axis of the first speaker 41 may be different from the front direction of the autonomous moving apparatus 100.

A front-rear direction that is the front direction of the autonomous moving apparatus 100 (straight-travelling direction) and a rear direction which is an opposite direction thereof is defined as an X axis direction. A vehicle width direction (left-right direction) which is perpendicular to the front-rear direction in a horizontal plane is defined as a Y axis direction. An up-down direction (vertical direction) which is perpendicular to both the front-rear direction (X axis direction) and the vehicle width direction (Y axis direction) is defined as a Z axis direction.

When viewed from the vertical direction, the first speaker 41, the first microphone 51L, and the second microphone 51R are located on the outside or outer periphery of the vehicle body 190. When an entirety of the vehicle body 190 when viewed from the vertical direction is divided into an outside area including an outer edge of the vehicle body 190 and an inside area surrounded by the outside area, the expression “the outside of the vehicle body 190” means the outside area of the vehicle body 190. The expression “the outer periphery of the vehicle body 190” means an area other than the vehicle body 190, surrounding the outside of the outer edge of the vehicle body 190, when viewed from the vertical direction. All of FIGS. 6A to 6C show examples in which the first speaker 41, the first microphone 51L, and the second microphone 51R are arranged on the outside of the vehicle body 190. All of FIGS. 7A to 7D show examples in which parts of a first speaker 41L and a second speaker 41R are arranged on the outer periphery of the vehicle body 190.

The first speaker 41, the first microphone 51L, and the second microphone 51R may be arranged on the front side of the vehicle body 190 in the front-rear direction. This reduces a distance to an object located in the front direction (positive direction of X axis), and can increase sound pressures of acoustic waves received by the first microphone 51L and the second microphone 51R. It is sufficient if a direction in which the first speaker 41 outputs an acoustic wave, and a direction in which the first microphone 51L and the second microphone 51R receive acoustic waves, are within a range from the front direction of the autonomous moving apparatus 100 to the left-right direction, and are toward the outside of the vehicle body 190. As a result, it is possible to receive acoustic waves coming from right and left oblique directions and the right and left sides, in addition to an acoustic wave coming from the front direction. This can avoid collision with peripheral objects when the autonomous moving apparatus 100 turns.

The first speaker 41 is interposed between the first microphone 51L and the second microphone 51R in the left-right direction (Y axis direction). In other words, the first microphone 51L and the second microphone 51R are arranged to have the first speaker 41 therebetween in the left-right direction (Y axis direction). As a result, the first microphone 51L and the second microphone 51R can be moved away from the first speaker 41 in the left-right direction. This can increase the sound pressure difference of acoustic waves received by the first microphone 51L and the second microphone 51R.

Distances from the first speaker 41 to each of the microphones 51L and 51R in the left-right direction are equal. This can reduce the left-right deviation of sound pressures of acoustic waves received by the microphones 51L and 51R. The autonomous moving apparatus 100 may have two or more speakers. In this case, distances from a center of gravity of a plurality of speakers including the first speaker 41 to each of the microphones 51L and 51R in the left-right direction are equal. As shown in FIGS. 7A to 7D, the autonomous moving apparatus 100 may have the second speaker 41R in addition to the first speaker 41L, for example. In this case, distances from a center of gravity C1 of the first speaker 41L and the second speaker 41R to each of the microphones 51L and 51R in the left-right direction are equal.

As described above, the first speaker 41, the first microphone 51L, and the second microphone 51R are located on the outside or outer periphery of the vehicle body 190, when viewed from an upper side in the vertical direction, the first speaker 41 is interposed between the first microphone 51L and the second microphone 51R in the left-right direction (Y axis direction), and distances from the first speaker 41 to each of the first microphone 51L and the second microphone 51R in the left-right direction are equal. This can increase the difference in sound pressures of acoustic waves received by the pair of left and right first microphone 51L and the second microphone 51R.

In the first embodiment, as shown in FIGS. 6A to 6C, the first speaker 41 faces the front direction of the autonomous moving apparatus 100 (positive direction of X axis). The first speaker 41L and the second speaker 41R may face a left oblique front direction and a right oblique front direction, respectively (FIG. 6A), may face the left side and right side, respectively (FIG. 6B), or may face the front direction (FIG. 6C). In order to eliminate the left-right deviation of sound pressures, orientations of the first microphone 51L and the second microphone 51R may be symmetrical, relative to a center C1 in the left-right direction of the vehicle body 190.

Further, in the first embodiment, as shown in FIGS. 7A to 7D, the autonomous moving apparatus 100 may further have the second speaker 41R which is attached to the vehicle body 190 and transmits an acoustic wave in the front direction (positive direction of X axis). In this case, the center of gravity C1 of the first speaker 41L and the second speaker 41R may be located between the first microphone 51L and the second microphone 51R in the left-right direction (Y axis direction). Distances from the center of gravity of the first speaker 41L and the second speaker 41R to each of the first microphone 51L and the second microphone 51R in the left-right direction are equal. This can reduce the left-right deviation of sound pressures of acoustic waves received by the first microphone 51L and the second microphone 51R. The first speaker 41L and the second speaker 41R may be arranged plane symmetrically, relative to a center plane (target plane) C1 in the left-right direction of the vehicle body 190. Further, orientations of the first speaker 41L and the second speaker 41R may be plane symmetrical, relative to the center plane C1 in the left-right direction of the vehicle body 190. The first speaker 41L and the first microphone 51L shown in FIG. 7A are attached at the same position and face the same front direction. In this case, the first speaker 41L and the first microphone 51L can be configured as one module (sensor for both transmission and reception). The same applies to the second speaker 41R and the second microphone 51R.

As shown in FIGS. 7A to 7D, at least parts of the first speaker 41L and the second speaker 41R are disposed on “the outer periphery of the vehicle body 190”. At least parts of the first speaker 41L and the second speaker 41R project in a front direction of a front end F1 of the vehicle body 19. This reduces a distance to a peripheral object, and can increase sound pressures of acoustic waves received by the first microphone 51L and the second microphone 51R. In addition, if the first speaker 41L and the second speaker 41R are arranged inside the vehicle body 190, instead of the outer periphery of the vehicle body 190, an output acoustic waves may be reflected by a surface of the vehicle body 190. In this case, the first microphone 51L and the second microphone 51R receive acoustic waves that are not reflected by obstacles, and the autonomous moving apparatus 100 causes malfunction or misrecognition. By arranging at least parts of the first speaker 41L and the second speaker 41R on “the outer periphery of the vehicle body 190”, it is possible to reduce a sound pressure of an acoustic wave which is reflected by the vehicle body 190 itself, which becomes noise.

Magnetic speakers or piezoelectric speakers can be used as the first speaker 41L and the second speaker 41R. Condenser microphones or piezoelectric type sensors can be used as the first microphone 51L and the second microphone 51R. As shown in FIG. 7A, when a speaker and a microphone are arranged at the same position and face the same direction, a pair of the speaker and microphone may form one module. The first speaker 41L and the second speaker 41R may be controlled to output ultrasonic waves at the same time period. The size of the first speaker 41L and second speaker 41R, and the first microphone 51L and second microphone 51R is assumed to be approximately 1 mm to 30 mm. Meanwhile, the width of the vehicle body 190 (length in left-right direction) is assumed to be approximately 20 cm to 1 m. In FIG. 7A, the size of the first speaker 41L and second speaker 41R, and the first microphone 51L and second microphone 51R, relative to the size of the vehicle body 190, is expressed to be larger than the real size. In FIGS. 6A to 6C, each of the first microphone 51L and the second microphone 51R is separated from the first speaker 41 by 2.5 cm or more in the left-right direction (Y axis direction), for example. The first microphone 51L and the second microphone 51R are separated from each other by 5 cm or more in the left-right direction (Y axis direction). Signals received by the first microphone 51L and the second microphone 51R are processed in the same control unit 130 as shown in FIGS. 3 to 5.

As shown in FIG. 8, the autonomous moving apparatus 100 may include the vehicle body 190, wheels 170, storage unit 140, drive unit 160, and composite unit 300 of a speaker-microphone for an autonomous moving apparatus. The vehicle body 190, wheels 170, storage unit 140, and drive unit 160 have already been described with reference to FIGS. 3 and 5, and therefore duplicated descriptions thereof will be omitted. The composite unit 300 is attached to an end F1 in the front direction of the vehicle body 190.

The composite unit 300 of a speaker-microphone for an autonomous moving apparatus is the composite unit 300 including a speaker and microphones used in the autonomous moving apparatus 100 described above. The composite unit 300 includes a casing 210 forming an outer shape of the composite unit 300, the first speaker 41 which is attached in the casing 210 and transmits an acoustic wave in a front direction of the composite unit 300 (positive direction of X axis), and the first microphone 51L and the second microphone 51R which are attached in the casing 210, receive acoustic waves reflected by objects in the periphery of the composite unit 300, and convert the acoustic waves into electric signals. The first speaker 41, and the first microphone 51L, and the second microphone 51R are located on the outside or outer periphery of the casing 210, when the composite unit 300 is viewed from the vertical direction. The first speaker 41 is interposed between the first microphone 51L and the second microphone 51R in the left-right direction (Y axis direction) perpendicular to the front direction (positive direction of X axis). Distances from the first speaker 41 or a center of gravity of a plurality of speakers including the first speaker 41, to each of the first microphone 51L and the second microphone 51R in the left-right direction (Y axis direction) are equal.

The first speaker 41 may be located at a front end F2 of the casing 210. The composite unit 300 may be fixed to the vehicle body 190 such that the front end F2 of the casing 210 is aligned with the front end F1 of the vehicle body 190. The casing 210 may be made of a metal or resin, for example.

By replacing the “vehicle body 190” shown in FIGS. 6A to 7D with the “casing 210” shown in FIG. 8, the composite unit shown in FIG. 8 may have a layout of the same speakers and microphones shown in FIGS. 6A to 7D. In this way, it is possible to apply, to the composite unit 300, the embodiment described with reference to FIGS. 6A to 7D, and an embodiment of the autonomous moving apparatus 100, which will be described later. Conversely, by replacing the “casing 210” with the “vehicle body 190”, the embodiment of the composite unit 300, which will be described later, can be applied to the autonomous moving apparatus 100. In other words, the embodiments of the autonomous moving apparatus 100 and the composite unit 300 can be applied to each other by mutually replacing the “vehicle body 190” and the “casing 210”.

Although FIG. 8 shows an example in which the control unit 130 is disposed in the casing 210 of the composite unit 300 (see FIGS. 3 to 5), the control unit 130 may be mounted on the vehicle body 190 instead being mounted in the composite unit 300.

### Second Embodiment

In a second embodiment, with reference to FIGS. 7E to 7H, a description will be given regarding the layout of the first speaker 41 and the composite unit 300 for increasing sound pressures of acoustic waves received by the first microphone 51L and the second microphone 51R from front directions or oblique front directions. FIGS. 7E and 7F show an embodiment of the autonomous moving apparatus 100, and FIGS. 7G and 7H show an embodiment of the composite unit 300. As shown in FIGS. 7E to 7H, the composite unit 300 is disposed at the front end F1 of the vehicle body 190. The first speaker 41 or the composite unit 300 is disposed at the end F1 of the vehicle body 190 in the front direction (positive direction of X axis), which is the straight-travelling direction of the autonomous moving apparatus. This reduces a distance to an object located in the front direction or oblique front direction, and increases a sound pressure of an acoustic wave reflected by the object. In addition, it is also possible to reduce an echo signal by the vehicle body 190 itself, which becomes noise, instead of an echo signal by an obstacle.

As shown in FIGS. 6A to 6C, the first speaker 41 may be disposed at the front end F1 of the vehicle body 190. Further, the first microphone 51L and the second microphone 51R may be disposed in a rear direction of the first speaker 41, or at the same position in the front-rear direction as the first speaker 41. This can reduce sound pressures of acoustic waves directly received by the first microphone 51L and the second microphone 51R from the first speaker 41.

As shown in FIGS. 7E to 7H, in order to avoid collision between an object and the first speaker 41 or composite unit 300, the autonomous moving apparatus 100 may further include a contact detection sensor 214 for detecting contact with an object. The contact detection sensor 214 is disposed in a front direction of the first speaker 41 or composite unit 300 (positive direction of X axis). The vehicle body 190 and the first speaker 41 are not disposed in a front direction of the contact detection sensor 214. The contact detection sensor 214, the first speaker 41 or composite unit 300, and the vehicle body 190 are disposed in this order from the front side. A contact point of the contact detection sensor 214 is arranged in a front direction of the first speaker 41 or composite unit 300. When the contact detection sensor 214 detects contact with an object, the autonomous moving apparatus 100 immediately stops. Collision between the object and the first speaker 41 or composite unit 300 can be avoided by stopping the autonomous moving apparatus 100 before collision between the object and the first speaker 41 or composite unit 300 occurs. Any kind of contact detection sensor 214 may be used, and a contact type detection sensor may be used therefor, for example. The contact detection sensor 214 may be arranged at the same position in the front-rear direction (X axis direction) as the first speaker 41 or composite unit 300. The can slightly prevent collision between the object and the first speaker 41 or composite unit 300.

As shown in FIGS. 7E and 7G, a part the first speaker 41 or an entirety of the composite unit 300 may project from the front end F1 of the vehicle body 190. The first speaker 41 is arranged at the front end F1 of the vehicle body 190. When viewed from the vertical direction, the first speaker 41 or composite unit 300 may be arranged on the outer periphery of the vehicle body 190 (FIG. 7E, FIG. 7G). Alternatively, as shown in FIGS. 7F and 7H, an entirety of the first speaker 41 or an entirety of the composite unit 300 may be disposed inside the vehicle body 190 instead of the front end F1 of the vehicle body 190.

When viewed from the vertical direction, the first speaker 41 or composite unit 300 may be disposed on the outside the vehicle body 190 (FIG. 7F, FIG. 7H). A position of the contact detection sensor 214 relative to the vehicle body 190 also changes according to a position of the first speaker 41 or composite unit 300 relative to the vehicle body 190. The second embodiment may be implemented in combination with one or more other embodiments.

### Third Embodiment

In a third embodiment, with reference to FIGS. 9 to 12, a description will be given regarding a structure of the vehicle body 190 or casing 210 for reducing a sound pressure of an acoustic wave (noise) coming from a rear direction. FIG. 9 is a plan view which shows an example of the composite unit 300 and shows a structure of the casing 210 for reducing a sound pressure of an acoustic wave (noise) coming from the rear direction, among acoustic waves received by the first microphone 51L and the second microphone 51R. The casing 210 includes sound pressure reducing units 210aL and 210aR which are disposed in the rear direction of the first microphone 51L and the second microphone 51R, and reduce sound pressures of a transmitted acoustic wave and a diffracted acoustic wave.

As shown in FIG. 9, the casing 210 has a convex planar shape in which a center portion in the left-right direction (Y axis direction) projects in the front direction (positive direction of X axis). The first microphone 51L and the second microphone 51R are arranged at openings of the casing 210 formed in side wall portions of the convex portion. The first microphone 51L and the second microphone 51R are attached such that they face the outside of the casing 210 in the left-right direction. In rear directions of the first microphone 51L and the second microphone 51R, the sound pressure reducing units 210aL and 210aR are arranged, respectively, which are parts of the casing 210, and prevent an acoustic wave S3 coming from a rear direction from directly entering the microphones, or reduce sound pressures thereof. A part of an acoustic wave S1 output from the first speaker 41 is reflected by an object 60A and is directed toward a rear direction as an acoustic wave S2. A part of the acoustic wave S2 is reflected by an object 60B arranged in a rear direction of the composite unit 300, and is directed toward the composite unit 300 (first microphone 51L) located in a front direction of the object 60B as the acoustic wave S3. The sound pressure reducing unit 210aL arranged in a rear direction of the first microphone 51L prevents the acoustic wave S3 from directly entering the microphone or reduces sound pressures thereof. Among acoustic waves received by the first microphone 51L and the second microphone 51R, an acoustic wave coming from a rear direction is unnecessary for the autonomous moving apparatus 100 to travel. The sound pressure reducing unit 210aL can reduce a sound pressure of an acoustic wave (noise) coming from a rear direction, among acoustic waves received by the first microphone 51L. The casing 210 has a symmetrical shape relative to the center in the left-right direction. Therefore, the sound pressure reducing unit 210aR can reduce a sound pressure of an acoustic wave (noise) coming from a rear direction, among acoustic waves received by the second microphone 51R.

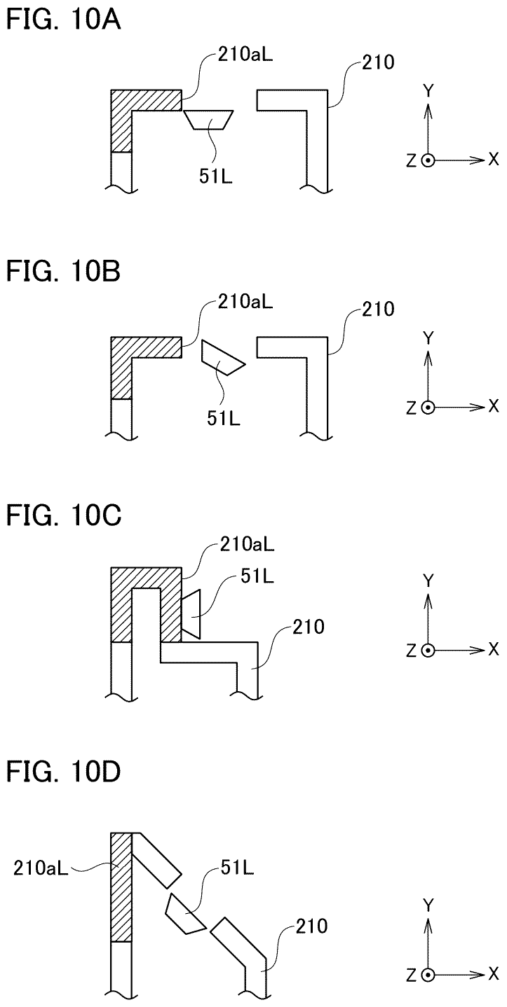

FIGS. 10A to 10D are plan views showing a modified example for reducing a sound pressure of an acoustic wave (noise) coming from a rear direction. As shown in FIG. 10A, the first microphone 51L facing a lateral direction (Y direction) is arranged inside the casing 210, instead of the openings in the casing 210. As a result, a part of the casing 210 located in a rear direction of the first microphone 51L functions as the sound pressure reducing unit 210aL. As shown in FIG. 10B, the first microphone 51L is located at the same position as the first microphone 51L in FIG. 10A, but an orientation of the first microphone 51L in FIG. 10B is caused to face an oblique front direction. This can reduce a sound pressure of an acoustic wave (noise) coming from a rear direction. Further, as shown in FIG. 10C, even if the casing 210 has no opening, a part of the casing 210 having a convex shape can function as the sound pressure reducing unit 210aL. Still further, as shown in FIG. 10D, when the casing 210 has an opening facing an oblique front direction, the first microphone 51L facing an oblique front direction is attached at the opening. As a result, a part of the casing 210 located in a rear direction of the first microphone 51L can function as the sound pressure reducing unit 210aL. With reference to FIGS. 10A to 10D, a left side portion of the casing 210 and the first microphone 51L have been described. However, a right side portion of the casing 210 and the second microphone 51R have the same configuration as the left side portion, because the composite unit 300 has a symmetrical planar shape.

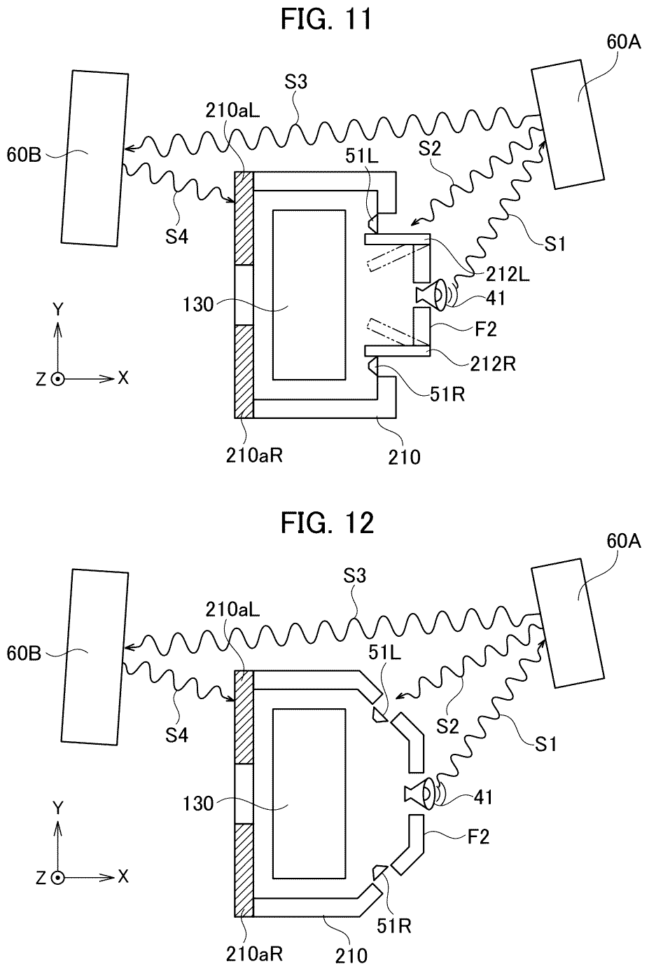

FIG. 11 is a plan view showing a modified example of the embodiment for reducing a sound pressure of an acoustic wave (noise) coming from a rear direction. In an example shown in FIG. 11, orientations of the first microphone 51L and the second microphone 51R face a front direction. As in FIG. 9, the first microphone 51L and the second microphone 51R receive acoustic waves from openings in the casing 210. Parts of the casing 210 disposed in a rear direction of the first microphone 51L and the second microphone 51R function as the sound pressure reducing units 210aL and 210aR.

FIG. 12 is a plan view showing a modified example of the embodiment for reducing a sound pressure of an acoustic wave (noise) coming from a rear direction. In an example shown in FIG. 12, openings in the casing 210 face oblique front directions. The first microphone 51L and the second microphone 51R are attached at the openings and face oblique front directions. As in FIG. 9, the first microphone 51L and the second microphone 51R receive acoustic waves from the openings in the casing 210. Part of the casing 210 arranged in a rear direction of the first microphone 51L and the second microphone 51R function as the sound pressure reducing units 210aL and 210aR. Although FIGS. 11 and 12 show the composite unit 300 with the casing 210 having the control unit 130 therein, the composite unit 300 may not have the control unit 130.

In the third embodiment, the example of the composite unit 300 has been described with reference to FIGS. 9 to 12, but it is also possible to implement the example by replacing the casing 210 of the composite unit 300 with the vehicle body 190 of the autonomous moving apparatus 100. As a result, it is possible to provide the autonomous moving apparatus 100 which achieves the same effect as the above-described composite unit 300. The third embodiment can be implemented in combination with one or more other embodiments.

### Fourth Embodiment

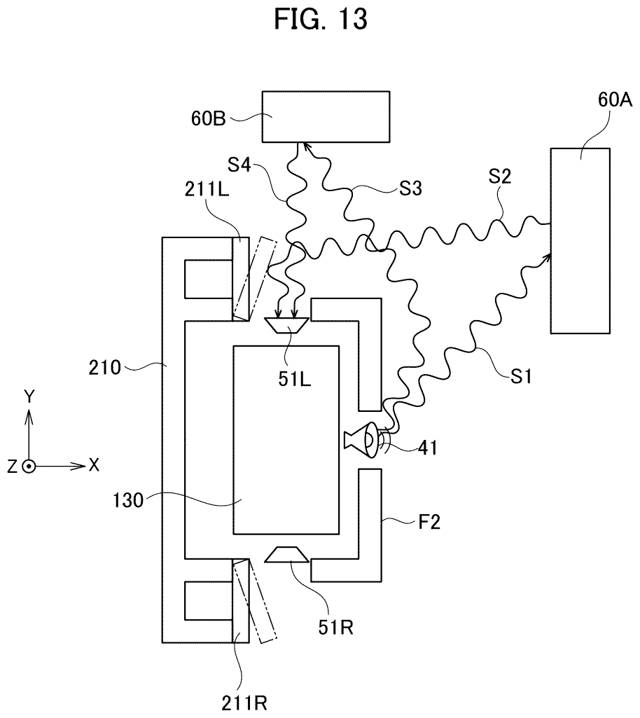

In a fourth embodiment, with reference to FIGS. 13 to 17B, a description will be given regarding structures of the composite unit 300 and autonomous moving apparatus 100 for increasing sound pressures of acoustic waves coming from oblique front directions to the pair of left and right first microphone 51L and the second microphone 51R, among acoustic waves received by the first microphone 51L and the second microphone 51R.

FIG. 13 is a plan view showing an example of a structure of the composite unit 300 for increasing sound pressures of acoustic waves coming from oblique front directions, among acoustic waves received by the first microphone 51L and the second microphone 51R. The composite unit 300 further includes a first reflecting member 211L which reflects an acoustic wave and is at least partially disposed in a rear direction of the first microphone 51L, and a second reflecting member 211R which reflects an acoustic wave and is at least partially disposed in a rear direction of the second microphone 51R. The reflecting members are a plate-like members (reflecting plates) having reflecting surfaces, for example.

The first microphone 51L and the second microphone 51R face the left-right direction and the outside of the casing 210. This enables the first microphone 51L and the second microphone 51R to receive acoustic waves coming from the outside of the casing 210.

Reflecting surfaces of the first reflecting member 211L and the second reflecting member 211R face the front direction (positive direction of X axis). As a result, the first reflecting member 211L and the second reflecting member 211R can reflect acoustic waves coming from oblique front directions toward the first microphone 51L and the second microphone 51R. This can increase sound pressures of acoustic waves coming from the oblique front directions which are received by the first microphone 51L and the second microphone 51R. The reflecting surfaces of the first reflecting member 211L and the second reflecting member 211R are formed on surfaces facing the first microphone 51L and the second microphone 51R. The reflecting surfaces may have a planar shape as shown in FIG. 13, or may have a spherical shape such as a hemispherical shape. If the reflecting surfaces have a planar shape, orientations of the reflecting surfaces are set at angles at which acoustic waves coming from oblique front directions are reflected toward the microphones 51L and 51R. If the reflecting surfaces have a spherical shape, positions and orientations of the reflecting surfaces are set such that reflected acoustic waves converge at positions of the microphones 51L and 51R.

A part of the acoustic wave S1 output from the first speaker 41 is reflected by the object 60A and is directed toward the first reflecting member 211L as the acoustic wave S2. The acoustic wave S2 is reflected by the first reflecting member 211L and is directed toward the first microphone 51L in a front direction. This can increase a sound pressure of the acoustic wave S2 coming from an oblique front direction to the first microphone 51L. It is also possible to increase a sound pressure of an acoustic wave coming from an oblique front direction to the second microphone 51R, because the composite unit 300 has a symmetrical planar shape.

The reflecting surfaces of the first reflecting member 211L and the second reflecting member 211R do not have to directly face the front direction (positive direction of X axis). In other words, the reflecting surfaces do not have to be accurately perpendicular to the front direction (positive direction of X axis). As shown in FIG. 13, the reflecting surfaces of the first reflecting member 211L and the second reflecting member 211R may be inclined toward the center side of the casing 210 in the left-right direction. As a result, as shown in FIG. 13, the first reflecting member 211L can reflect the acoustic wave S2, which has been reflected by the object 60A located in an oblique front direction, toward the first microphone 51L.

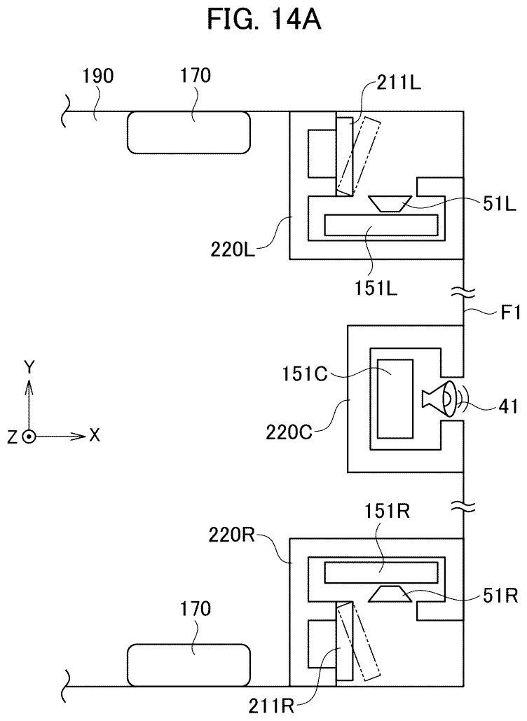

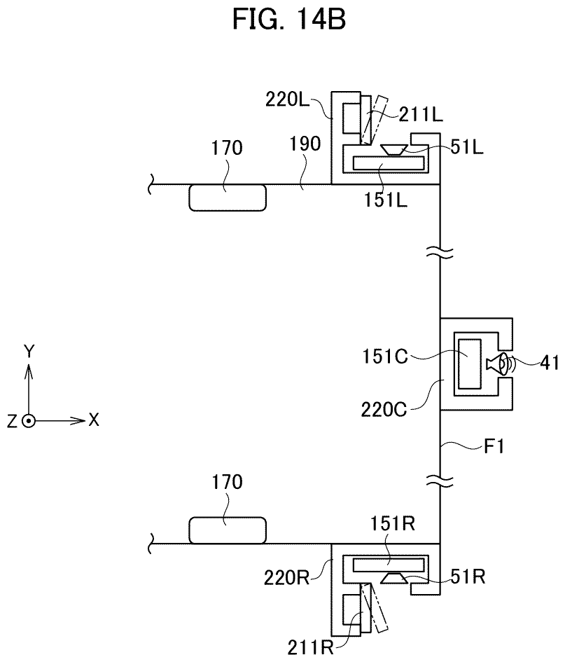

FIG. 14A shows an example of a structure of the autonomous moving apparatus 100 for increasing a sound pressure of an acoustic wave coming from an oblique front direction, among acoustic waves received by the first microphone 51L and the second microphone 51R. While FIG. 13 shows the example of the composite unit 300, FIG. 14A shows an example of the autonomous moving apparatus 100 with the vehicle body 190 on which the speaker 41 and the microphones 51L and 51R are individually attached.

The first speaker 41 is arranged in a speaker casing 220C, the first microphone 51L is arranged in a first microphone casing 220L, and the second microphone 51R is arranged in a second microphone casing 220R. The speaker casing 220C, the first microphone casing 220L, and the second microphone casing 220R are mounted on the vehicle body 190. A circuit 151C including the amplifier 42 and the D/A conversion unit 43 may be arranged in the casing 220C. A circuit 151L having the A/D conversion unit 53L and a circuit 151R having the A/D conversion unit 53R may be arranged in the casing 220L and the casing 220R, respectively.

Positions and orientations of the first microphone 51L and the second microphone 51R relative to the vehicle body 190 in FIG. 14A are the same as the positions and orientations of the first microphone 51L and the second microphone 51R relative to the casing 210 in FIG. 13. Positions and orientations of the first reflecting member 211L and the second reflecting member 211R relative to the first microphone 51L and the second microphone 51R in FIG. 14A are the same as those in FIG. 13.

FIG. 14A shows an example in which the casings 220C, 220L, and 220R are arranged on the outside of the vehicle body 190, and the first speaker 41, the first microphone 51L, and the second microphone 51R are arranged on the outside of the vehicle body 190. That is, the first speaker 41, the first microphone 51L, and the second microphone 51R are arranged inside of the outer edge of the vehicle body 190. However, the speaker and microphones are not limited thereto, and as shown in FIG. 14B, the casings 220C, 220L, and 220R, the first speaker 41, the first microphone 51L, and the second microphone 51R may be arranged on the outer periphery of the vehicle body 190, that is, may be arranged on the outside of the outer edge of the vehicle body 190. In this case, the first speaker 41 is located in a front direction of the front end F1 of the vehicle body 190. This reduces a distance between the first speaker 41 and an object in a front direction, and can increase a sound pressure of an acoustic wave reflected by the object. In addition, it is possible to reduce an echo signal of the vehicle body 190 itself, which becomes noise, instead of an echo signal by an obstacle (object in front direction). The first microphone 51L and the second microphone 51R are arranged on the outer periphery of the vehicle body 190 in the left-right direction. This further increases a distance between the first microphone 51L and the second microphone 51R, compared to that in FIG. 14A. Therefore, as described in the first embodiment, it is possible to further increase the difference in sound pressures of left and right acoustic waves. The autonomous moving apparatus 100 shown in FIGS. 14A and 14B may have the contact detection sensor 214 shown in FIGS. 7E to 7H.

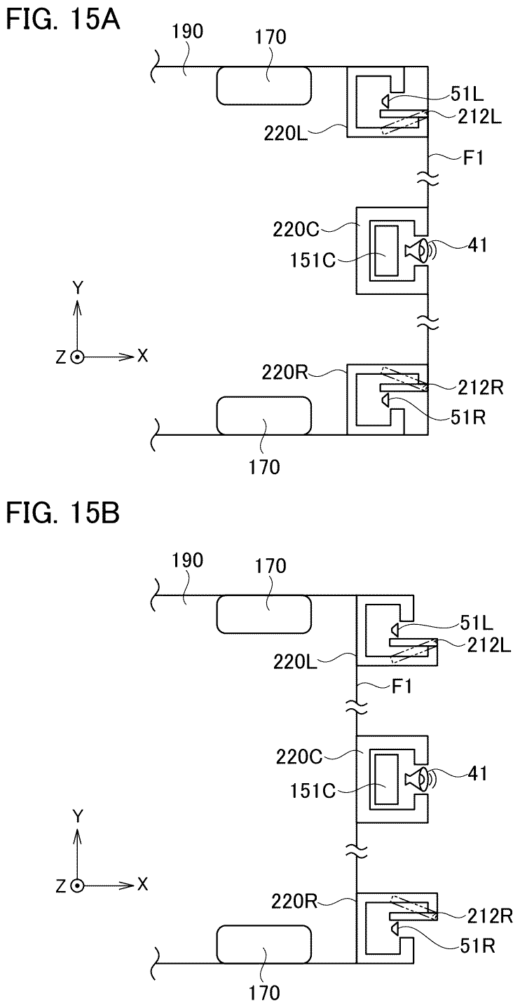

FIG. 15A shows another example of a structure of the autonomous moving apparatus 100 for increasing a sound pressure of an acoustic wave coming from an oblique front direction, among acoustic waves received by the first microphone 51L and the second microphone 51R. FIGS. 15A and 15B show examples in which the first microphone 51L and the second microphone 51R face the front direction (positive direction of X axis).

The autonomous moving apparatus 100 further includes a first reflecting member 212L which reflects an acoustic wave and is at least partially disposed inside of the vehicle body 190 in the left-right direction (Y axis direction) of the first microphone 51L, and a second reflecting member 212R which reflects an acoustic wave and is at least partially disposed inside of the vehicle body 190 in the left-right direction of the second microphone 51R. Reflecting surfaces of the first reflecting member 212L and the second reflecting member 212R face the outside in the left-right direction. The reflecting surfaces of the first reflecting member 212L and the second reflecting member 212R are formed on surfaces facing the first microphone 51L and the second microphone 51R. As a result, the first reflecting member 212L and the second reflecting member 212R can reflect acoustic waves coming from oblique front directions toward the first microphone 51L and the second microphone 51R. This can increase sound pressures of the acoustic waves coming from the oblique front directions, which are received by the first microphone 51L and the second microphone 51R. The reflecting surfaces may have a planar shape as shown in FIGS. 15A and 15B, or may have a spherical shape such as a hemispherical shape. If the reflecting surfaces have a planar shape, orientations of the reflecting surfaces are set at angles at which the acoustic waves coming from the oblique front directions are reflected toward the microphones 51L and 51R. If the reflecting surfaces have a spherical shape, positions and orientations of the reflecting surfaces are set such that the reflected acoustic waves converge at positions of the microphones 51L and 51R.

The reflecting surfaces of the first reflecting member 212L and the second reflecting member 212R do not have to directly face the outside in the left-right direction (Y axis direction). In other words, the reflecting surfaces do not have to be accurately perpendicular to the outside in the left-right direction (Y axis direction). As shown in FIGS. 15A and 15B, the reflecting surfaces of the first reflecting member 212L and the second reflecting member 212R may be inclined toward a rear direction (negative direction of X axis). As a result, the first reflecting member 212L and the second reflecting member 212R can reflect acoustic waves, which have been reflected by objects located in oblique front directions, toward the first microphone 51L and the second microphone 51R.

As in FIG. 14A, the first speaker 41, the first microphone 51L, and the second microphone 51R shown in FIG. 15A are housed in the casing 220C, the casing 220L, and the casing 220R, respectively. The casings 220C, 220L, and 220R are disposed on the outside of the vehicle body 190, and the first speaker 41, the first microphone 51L, and the second microphone 51R are disposed on the outside of the vehicle body 190. In addition, as shown in FIG. 15B, the casings 220C, 220L, and 220R, the first speaker 41, the first microphone 51L, and the second microphone 51R may be disposed on the outer periphery of the vehicle body 190. In this case, the first speaker 41, the first microphone 51L, and the second microphone 51R are located in the front direction of the front end F1 of the vehicle body 190. This reduces a distance to an object located in a front direction, and can increase a sound pressure of an acoustic wave reflected by the object. Further, it is also possible to reduce an echo signal of the vehicle body 190 itself, which becomes noise.

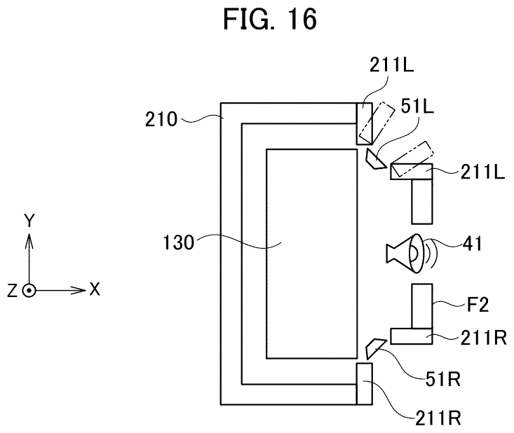

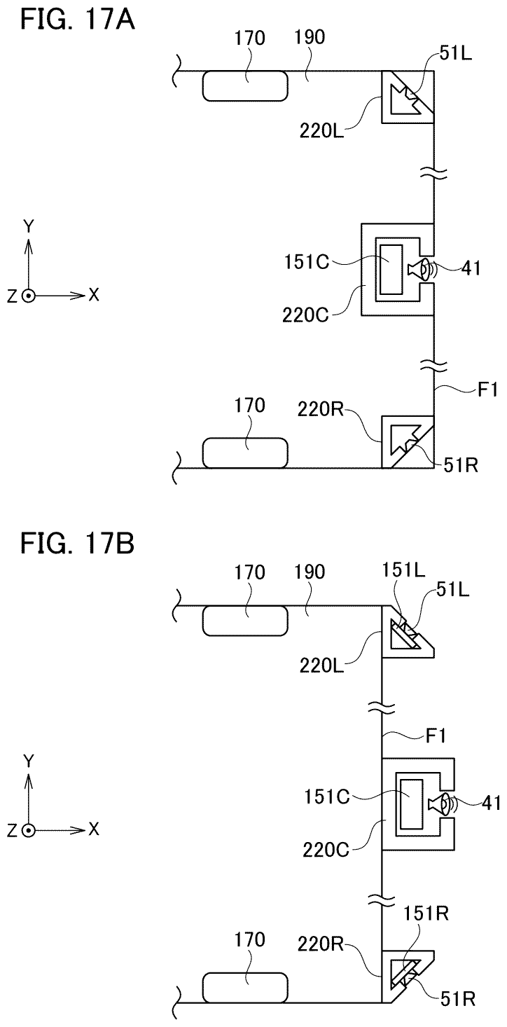

FIG. 16 shows another example of a structure of the composite unit 300 for increasing a sound pressure of an acoustic wave coming from an oblique front direction, among acoustic waves received by the first microphone 51L and the second microphone 51R. FIGS. 16 to 17B show examples in which the first microphone 51L and the second microphone 51R face oblique front directions.

In the composite unit 300 shown in FIG. 16, orientations of the first microphone 51L and the second microphone 51R are inclined to the outside of the casing 210 in the left-right direction (Y axis direction) from the front direction (positive direction of X axis). Specifically, the first microphone 51L is inclined on the left side from the front direction. The second microphone 51R is inclined on the right side from the front direction. As a result, it is possible to increase sound pressures of acoustic waves coming from oblique front directions, among acoustic waves received by the first microphone 51L and the second microphone 51R. An angle of inclination is larger than 0 degrees and 90 degrees or less, for example. The composite unit 300 shown in FIG. 16 further includes the first reflecting member 211L and the second reflecting member 211R arranged in the periphery of the first microphone 51L and the second microphone 51R. Reflecting surfaces of the first reflecting member 211L and the second reflecting member 211R are formed on surfaces of the first microphone 51L and the second microphone 51R. As a result, the first reflecting member 211L and the second reflecting member 211R can reflect acoustic waves coming from oblique front directions toward the first microphone 51L and the second microphone 51R. Due to the first microphone 51L and the second microphone 51R facing oblique front directions, it is possible to increase sound pressures of acoustic waves coming from the oblique front directions. The composite unit 300, which does not have the first reflecting member 211L and the second reflecting member 211R shown in FIG. 12, has the first microphone 51L and the second microphone 51R facing the oblique front directions in FIG. 16. Therefore it is possible to increase sound pressures of acoustic waves coming from oblique front directions. Therefore, the composite unit 300 shown in FIG. 12 is also included in the fourth embodiment.

FIGS. 17A and 17B show another example of a structure of the autonomous moving apparatus 100 for increasing a sound pressure of an acoustic wave coming from an oblique front direction, among acoustic waves received by the first microphone 51L and the second microphone 51R. FIGS. 17A and 17B show examples in which the first microphone 51L and the second microphone 51R face oblique front directions. As in FIG. 14A, the first speaker 41, the first microphone 51L, and the second microphone 51R shown in FIGS. 17A and 17B are housed in the casing 220C, the casing 220L, and the casing 220R, respectively. The circuit 151C having the amplifier 42 and the D/A conversion unit 43 may be arranged in the casing 220C. The circuit 151L having the A/D conversion unit 53L and the circuit 151R having the A/D conversion unit 53R may be arranged in the casing 220L and the casing 220R, respectively.

As shown in FIG. 17A, each of the casings 220C, 220L, and 220R may be arranged on the outside the vehicle body 190 and may be in contact with the front end F1 of the vehicle body 190. This can increase a sound pressure of an acoustic wave coming from a front direction. In addition, it is possible to reduce an echo signal of the vehicle body 190 itself, which becomes noise. In addition, the casings 220L and 220R are in contact with ends of the vehicle body 190 in the left-right direction. This can separate the first microphone 51L and the second microphone 51R in the left-right direction. Therefore, it is possible to increase the difference in sound pressures of acoustic waves received by the pair of left and right first microphone 51L and second microphone 51R. Parts of the casings 220L and 220R located in a rear direction of the first microphone 51L and the second microphone 51R function as sound pressure reducing units.

As shown in FIG. 17B, each of the casings 220C, 220L, and 220R may be disposed on the outer periphery of the vehicle body 190, and may be in contact with the front end F1 of the vehicle body 190. The casings 220C, 220L, and 220R are attached in a further front direction of the vehicle body 19, compared to those in FIG. 17A. This can increase sound pressures of acoustic waves coming from front directions which are received by the first microphone 51L and the second microphone 51R. In addition, it is possible to reduce an echo signal of the vehicle body 190 itself, which becomes noise. The autonomous moving apparatus 100 shown in FIGS. 17A and 17B may have the contact detection sensor 214 shown in FIGS. 7E to 7H.

### Fifth Embodiment

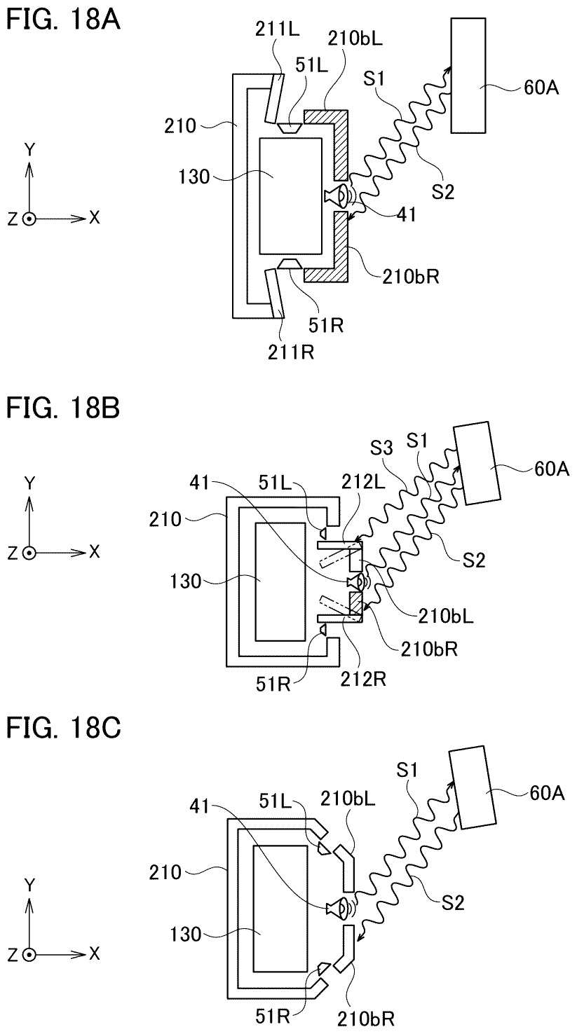

In a fifth embodiment, with reference to FIGS. 18A to 18C, a description will be given regarding a structure of the composite unit 300 for reducing sound pressures of acoustic waves coming from right and left opposite sides, among acoustic waves received by the first microphone 51L and the second microphone 51R. The pair of left and right first microphone 51L and second microphone 51R increase a sound pressure of an acoustic wave coming from the same side, left or right, and reduce sound pressures of acoustic waves coming from the right and left opposite sides. This can increase the difference in sound pressures of acoustic waves received by the pair of left and right first first microphone 51L and second microphone 51R.

FIG. 18A is a plan view showing an example of a structure of the composite unit 300 for reducing sound pressures of acoustic waves coming from the right and left opposite sides, among acoustic waves received by the first microphone 51L and the second microphone 51R. FIGS. 18B and 18C are plan views, each showing another example of a structure of the composite unit 300 for reducing sound pressures of acoustic waves coming from the right and left opposite sides, among acoustic waves received by the first microphone 51L and the second microphone 51R. As shown in FIGS. 18A to 18C, the casing 210 of the composite unit 300 has a first sound pressure reducing unit 210bL and a second sound pressure reducing unit 210bR. The first sound pressure reducing unit 210bL is a portion of the casing 210 which reduces a sound pressure of a transmitted acoustic wave, and which is located on the outside of the casing 210 and on the outside of a first line segment connecting the first speaker 41 and the first microphone 51L, when viewed from the vertical direction (Z axis direction). The second sound pressure reducing unit 210bR is a portion of the casing 210 which reduces a sound pressure of a transmitted acoustic wave, and which is located on outside of the casing 210 and on the outside of a second line segment connecting the first speaker 41 and the second microphone 51R, when viewed from the vertical direction. The first sound pressure reducing unit 210bL and the second sound pressure reducing unit 210bR may be made of the same material as the casing 210, or may be made of a material different from that of the casing 210, such as a material that absorbs an acoustic wave, for example. Members that reflect acoustic waves may be disposed on surfaces of the first sound pressure reducing unit 210bL and the second sound pressure reducing unit 210bR.

The acoustic wave S1 output from the first speaker 41 is reflected by the object 60A located in a left oblique front direction. The acoustic wave S2 directed toward the second microphone 51R, of the reflected acoustic wave, is prevented from directly entering the second microphone 51R by the second sound pressure reducing unit 210bR, or a sound pressure thereof is reduced. In this way, it is possible to reduce sound pressures of acoustic waves coming from the right and left opposite sides, among acoustic waves received by the first microphone 51L and the second microphone 51R.

The first sound pressure reducing unit 210bL and the second sound pressure reducing unit 210bR are also implemented in the casings 210, 220C, 220L, and 220R shown in FIGS. 9, 11, 12, 13, 14A, 14B, 15A, 15B, 16, 17A, and 17B. The fifth embodiment can be implemented in combination with one or more other embodiments. The structure of the composite unit 300 shown in FIGS. 18A to 18C shows an example obtained by combining the second embodiment for increasing a sound pressure of an acoustic wave received from a front direction or an oblique front direction, the third embodiment for reducing a sound pressure of an acoustic wave (noise) coming from a rear direction, and the fourth embodiment for increasing sound pressures of acoustic waves coming from an oblique front direction to the pair of left and right microphones 51L and 51R, for example.

### Sixth Embodiment

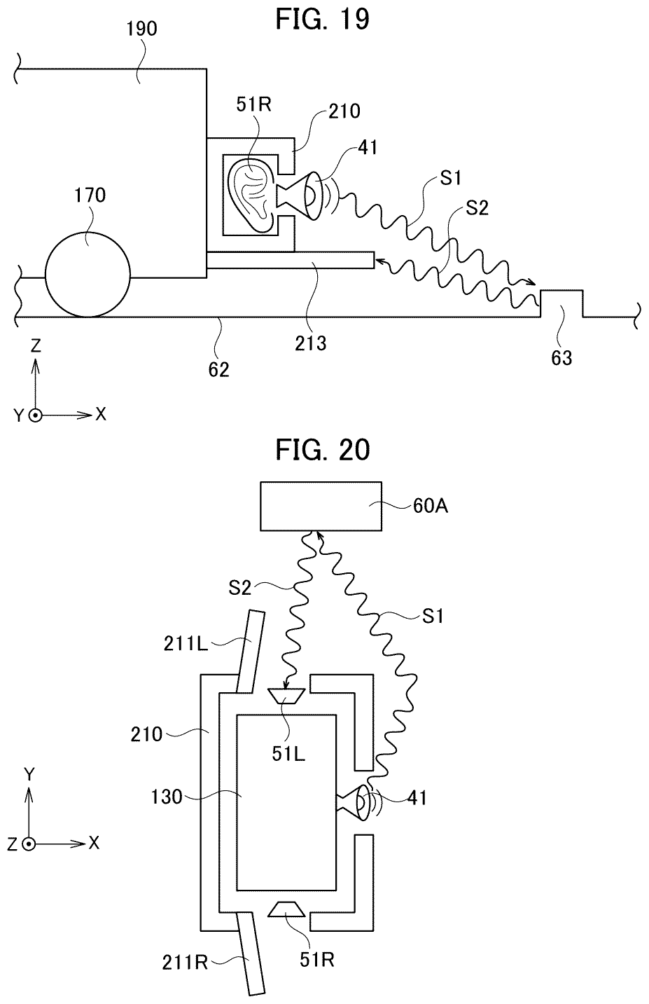

In a sixth embodiment, with reference to FIG. 19, a description will be given regarding structures of the composite unit 300 and the autonomous moving apparatus 100 for reducing a sound pressure of an acoustic wave (noise) reflected by an unevenness 63 on a ground 62, among acoustic waves received by the first microphone 51L and the second microphone 51R. The composite unit 300 further includes a projecting member 213 which reduces a sound pressure of a transmitted acoustic wave and which projects in a traveling direction of an acoustic wave from a lower portion of at least one of the first speaker 41, the first microphone 51L, and the second microphone 51R.

An expression “a traveling direction of an acoustic wave” is a concept including a direction in which an acoustic wave is output from the first speaker 41, and a direction in which the first microphone 51L and the second microphone 51R receive acoustic waves. FIG. 19 shows the composite unit 300 having one casing 210 on which the first speaker 41, first microphone 51L, and second microphone 51R are attached, and shows an example in which the projecting member 213 projects in the front direction (positive direction of X axis) from lower surfaces of the first microphone 51L and the second microphone 51R. Meanwhile, the first speaker 41, the first microphone 51L, and the second microphone 51R may be individually attached directly on the vehicle body 190, unlike those in the composite unit 300. In this case, the projecting member 213 projects in the front direction (positive direction of X axis) from a lower surface of each of the first speaker 41, the first microphone 51L, and the second microphone 51R. The projection amount is in a range from 2 cm to 10 cm, for example. A material of the projecting member 213 may be the same as that of the casing 210 or the vehicle body 190, or the projecting member 213 may be made of a material different from that of the casing 210 or the vehicle body 190, such as a material which absorbs an acoustic wave or a material which reflects an acoustic wave, for example.

The acoustic wave S1 output from the first speaker 41 is reflected by the unevenness 63 on the ground 62 on which the autonomous moving apparatus 100 travels, and when the acoustic wave S2 reflected toward the first microphone 51L or the second microphone 51R passes through the projecting member 213, a sound pressure thereof is reduced. As a result, it is possible to reduce a sound pressure of an acoustic wave (noise) reflected by the unevenness 63 on the ground 62, among acoustic waves received by the first microphone 51L and the second microphone 51R. Although not shown in FIG. 19, if the projecting member 213 projects in a front direction from a lower surface of the first speaker 41, and when the acoustic wave S1 output from the first speaker 41 passes through the projecting member 213, a sound pressure thereof is reduced. The acoustic wave S1 may be reflected by the projecting member 213.

### Seventh Embodiment

In a seventh embodiment, with reference to FIG. 20, a description will be given regarding structures of the composite unit 300 and the autonomous moving apparatus 100 for preventing the object 60A in a lateral direction from being entangled by increasing a sound pressure of an acoustic waves coming from a lateral direction of the autonomous moving apparatus 100. As shown in FIG. 20, the entire first reflecting member 211L is disposed in a rear direction of the first microphone 51L. Similarly, the entire second reflecting member 211R is disposed in a rear direction of the second microphone 51R. That is, when the first microphone 51L is viewed from the outside in the left-right direction (left side), the entire first microphone 51L is visible without being shielded by the first reflecting member 211L. Similarly, when the second microphone 51R is viewed from the outside in the left-right direction (right side), the entire second microphone 51R is visible without being shielded by the second reflecting member 211R.

The acoustic wave S1 output from the first speaker 41 is reflected by a surface of the object 60A located on the left side of the autonomous moving apparatus 100, and the acoustic wave S2 reflected toward the first microphone 51L can reach the first microphone 51L without being shielded by the first reflecting member 211L. Therefore, it is possible to detect the object 60A in the lateral directing by increasing a sound pressure of an acoustic wave coming from the lateral direction of the autonomous moving apparatus 100 having the composite unit 300 shown in FIG. 20, and this can prevent the autonomous moving apparatus 100 from entangling the object 60A when turning left. It is possible to enhance the sensitivity of the first microphone 51L and the second microphone 51R to an acoustic wave coming from the lateral direction of the autonomous moving apparatus 100.

In the examples shown in FIGS. 13, 14A, and 14B, the first reflecting member 211L and the second reflecting member 211R are inclined largely to the inside of the composite unit 300 in order to increase sound pressures of acoustic waves coming from oblique front directions to the pair of left and right microphones 51L and 51R. Therefore, when the first microphone 51L and the second microphone 51R are viewed from the outside in the left-right direction, parts of the first microphone 51L and the second microphone 51R are not visible due to the presence of the first reflecting member 211L and the second reflecting member 211R. Meanwhile, in the example shown in FIG. 20, an inclination angle is set to be small so that the entire first microphone 51L and the entire second microphone 51R are visible. The inclination angle is not limited thereto, and even if inclination angles of the first reflecting member 211L and the second reflecting member 211R remain large, if positions thereof are moved in a further rear direction (negative direction of X axis), the entire first microphone 51L and the entire second microphone 51R become visible. The seventh embodiment can also be applied to the structure of the autonomous moving apparatus 100 by replacing the casing 210 shown in FIG. 20 with the vehicle body 190.

The seventh embodiment can be implemented in combination with one or more other embodiments. Due to the presence of the first reflecting member 211L and the second reflecting member 211R shown in FIG. 20, it is possible to obtain an effect of reducing a sound pressure of an acoustic wave (noise) coming from a rear direction (third embodiment), and an effect of increasing sound pressures of acoustic waves coming from oblique front directions to the pair of left and right microphones 51L and 51R (fourth embodiment). Since parts of the casing 210 located on the outside of the line segment connecting the microphone 51L and the first speaker 41 and the line segment connecting the microphone 51R and the first speaker 41 function as sound pressure reducing units, it is possible to obtain an effect of reducing sound pressures of acoustic waves coming from right and left opposite sides (fifth embodiment). That is, the example shown in FIG. 20 is an example obtained by combining the third to fifth embodiments.

### Eighth Embodiment

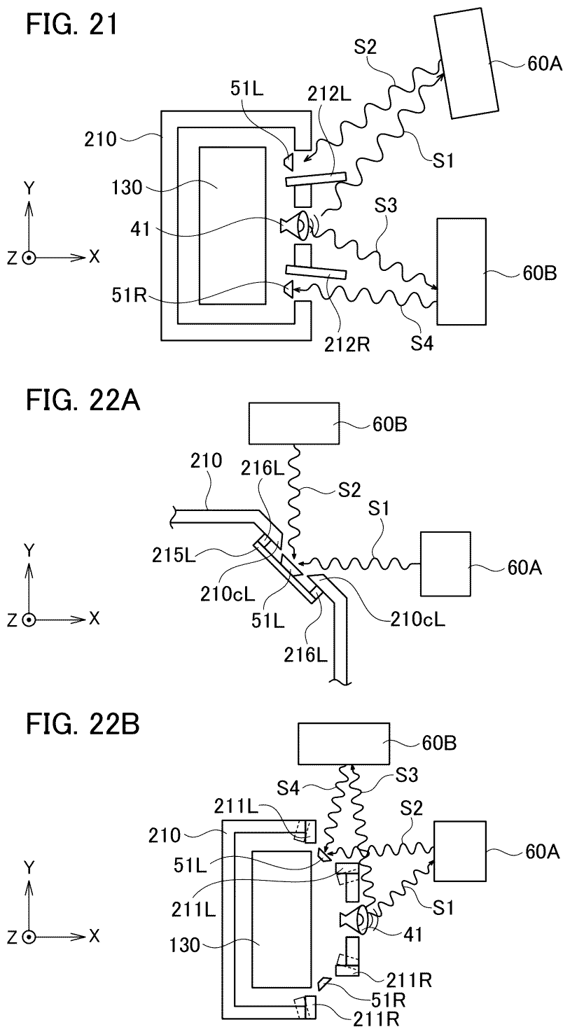

In an eighth embodiment, with reference to FIG. 21, a description will be given regarding structures of the composite unit 300 and the autonomous moving apparatus 100 for preventing collisions with the objects 60A and 60B in a front direction of the autonomous moving apparatus 100 by increasing a sound pressure of an acoustic wave coming from the front direction. As shown in FIG. 21, the entire first reflecting member 212L is disposed in the inner side of the casing 210 in the left-right direction of the first microphone 51L. Similarly, the entire second reflecting member 212R is disposed in the inner side of the casing 210 in the left-right direction of the second microphone 51R. That is, when the first microphone 51L is viewed from the front direction, the entire first microphone 51L is visible without being shielded by the first reflecting member 212L. Similarly, when the second microphone 51R is viewed from the front direction, the entire second microphone 51R is visible without being shielded by the second reflecting member 212R.

The acoustic wave S1 output from the first speaker 41 is reflected by a surface of the object 60A located in the front direction of the autonomous moving apparatus 100, and the acoustic wave S2 reflected toward the first microphone 51L can reach the first microphone 51L without being shielded by the first reflecting member 212L. Therefore, it is possible to detect the object 60A in the front direction of the autonomous moving apparatus 100 by increasing a sound pressure of an acoustic wave coming from the front direction, and this can prevent collision with the object 60A. Similarly, the acoustic wave S3 output from the first speaker 41 is reflected by a surface of the object 60B located in the front direction of the autonomous moving apparatus 100, and an acoustic wave S4 reflected toward the second microphone 51R can reach the second microphone 51R without being shielded by the second reflecting member 212R. Therefore, it is possible to detect the object 60B in the front direction of the autonomous moving apparatus 100 by increasing a sound pressure of an acoustic wave coming from the front direction, and this can prevent collision with the object 60A. It is possible to enhance the sensitivity of the first microphone 51L and the second microphone 51R to an acoustic wave coming from the front direction of the autonomous moving apparatus 100.

Due to the presence of the first reflecting member 212L and the second reflecting member 212R in FIG. 21, it is possible to obtain an effect of increasing sound pressures of acoustic waves coming from oblique front directions to the pair of left and right microphones 51L and 51R (fourth embodiment), and an effect of reducing sound pressures of acoustic waves coming from right and left opposite sides (fifth embodiment). That is, the example shown in FIG. 20 is an example obtained by combining the fourth and fifth embodiments. It is needless to say that parts of the casing 210 located in a rear direction of the first microphone 51L and the second microphone 51R form sound pressure reducing units for reducing sound pressures of acoustic waves (noise) coming from a rear direction (third embodiment).

### Ninth Embodiment

In a ninth embodiment, with reference to FIGS. 22A and 22B, a description will be given regarding structures of the composite unit 300 and the autonomous moving apparatus 100 for increasing a sound pressure of an acoustic waves coming from at least one of a front direction and a lateral direction, while increasing sound pressures of acoustic waves coming from oblique front directions to the pair of left and right microphones 51L and 51R. FIG. 22A shows a modified example of the composite unit 300 shown in FIGS. 12 and 18C, and is a plan view showing an enlarged view of parts of the first microphone 51L and the casing 210 in the periphery thereof.

As shown in FIG. 22A, portions of the first microphone 51L and the second microphone 51R that receive acoustic waves may be visible from the outside of the casing 210 in at least one of a front direction and a left-right direction. Entire tips of acoustic horns of the first microphone 51L and the second microphone 51R may be visible from the outside of the casing 210 in at least one of the front direction (X axis direction) and the left-right direction (Y axis direction), for example. Orientations of the first microphone 51L and the second microphone 51R are inclined to the outside of the casing 210 in the left-right direction (Y axis direction) from the front direction (positive direction of X axis).

In FIGS. 12 and 18C, portions of the first microphone 51L and the second microphone 51R are shielded by the casing 210. Specifically, edge portions of an opening in the casing 210 hide the portions of the first microphone 51L and the second microphone 51R. In the example of FIG. 22A, the side of an opening of the casing 210 in which the first microphone 51L and the second microphone 51R are arranged is inclined such that the opening becomes wide toward the outside of the casing 210. As a result, the portions of the first microphone 51L and the second microphone 51R that receive acoustic waves are visible from the outside of the casing 210 in at least one of the front direction and the left-right direction. Therefore, while increasing sound pressures of acoustic waves coming from oblique front directions to the pair of left and right microphones 51L and 51R, it is also possible to increase a sound pressure of an acoustic wave coming from at least one of a front direction and a lateral direction.

FIG. 22B is a plan view showing another example of a structure of the composite unit 300 for increasing a sound pressure of an acoustic wave coming from at least one of a front direction and a lateral direction, while increasing sound pressures of acoustic waves coming from oblique front directions to the pair of left and right microphones 51L and 51R. The composite unit 300 further includes the first reflecting member 211L that is arranged in the periphery of the first microphone 51L and reflects an acoustic wave toward a portion of the first microphone 51L which receives an acoustic wave, and the second reflecting member 211R that is arranged in the periphery of the second microphone 51R and reflects an acoustic wave toward a portion of the second microphone 51R which receives an acoustic wave. As in FIG. 22A, portions of the first microphone 51L and the second microphone 51R which receive acoustic waves are visible from the outside of the casing 210 in at least one of a front direction (positive direction of X axis) and a left-right direction (Y axis direction). Due to the composite unit 300 having the first reflecting member 211L and the second reflecting member 211R, while increasing sound pressures of acoustic waves coming from oblique front directions to the pair of left and right microphones 51L and 51R, it is also possible to further increase a sound pressure of an acoustic wave coming from at least one of a front direction and a lateral direction. Reflecting surfaces of the first reflecting member 211L and the second reflecting member 211R may directly face outside of the casing 210 in a front direction or a left-right direction (Y axis direction), or may be inclined.

Further, as a modified example of FIGS. 9, 11, 13, 14A, 14B, 15A, 15B, 16, 18A, 20, and 22B, a convex casing 210 may be formed by reducing a portion of a rectangular casing, and portions of the casing 210 may function as the first reflecting member 211L and the second reflecting member 211R or the first reflecting member 212L and the second reflecting member 212R. Alternatively, as a modified example of FIG. 21, a concave casing 210 may be formed, and side surfaces of the concave portion which is a part of the casing 210 may function as the first reflecting member 212L and the second reflecting member 212R.

Although the example of the composite unit 300 has been described in the ninth embodiment, the example can be implemented by replacing the casing 210 of the composite unit 300 with the vehicle body 190 of the autonomous moving apparatus 100. As a result, it is possible to provide the autonomous moving apparatus 100 which achieves the same effect as the composite unit 300 described above. The ninth embodiment may be implemented in combination with one or more other embodiments.

### Tenth Embodiment

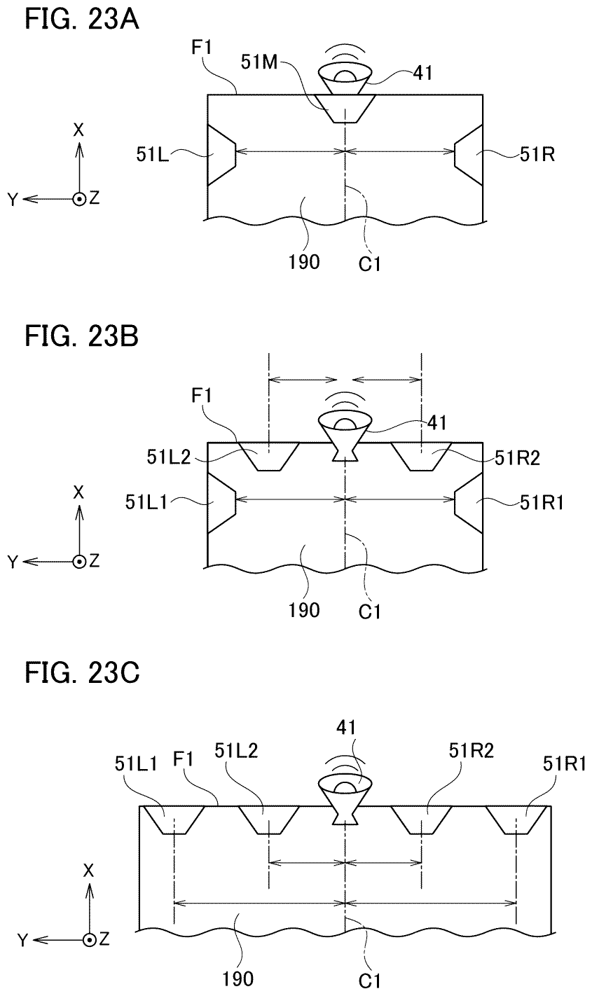

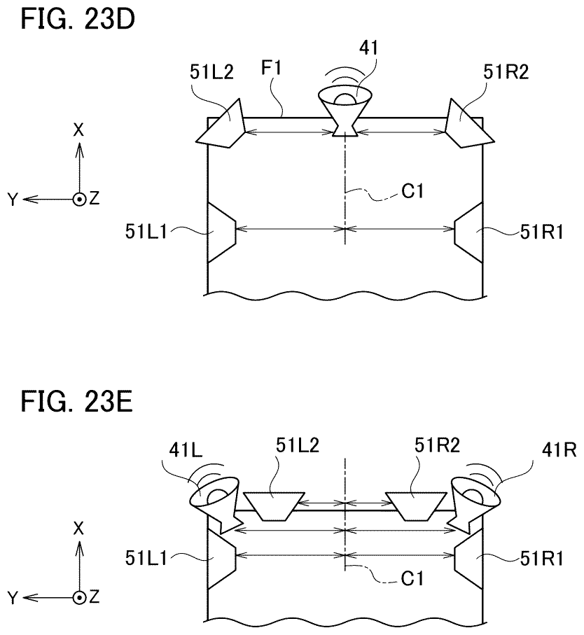

In a tenth embodiment, with reference to FIGS. 23A to 23E, another modified example of the number and arrangement of microphones and speakers of the autonomous moving apparatus 100 will be described. FIGS. 6A to 6C show configuration examples in which the number of speaker is one and the number of microphones is two, and FIGS. 7A to 7D show configuration examples in which the number of speakers is two and the number of microphones is two. In the tenth embodiment, an example in which the number of microphones is three or four will be described.

As shown in FIG. 23A, the autonomous moving apparatus 100 may further include a third microphone 51M which is attached to the vehicle body 190, receives an acoustic wave reflected by an object, and converts the acoustic wave into an electric signal. The first speaker 41, the first microphone 51L, the second microphone 51R, and the third microphone 51M are arranged plane symmetrically, relative a single target plane C1. The third microphone 51M is attached to the front end F1 of the vehicle body 190 and to the center of the vehicle body 190 in a left-right direction, to face an area including a front direction. The single target plane C1 is the center plane C1 which is parallel to a plane including a front-rear direction and an up-down direction of the autonomous moving apparatus 100 (X Z plane) and includes the center of the vehicle body 190 in the left-right direction. Positions and orientations of the first speaker 41, the first microphone 51L, the second microphone 51R, and the third microphone 51M are plane symmetrical, relative to the center plane C1. The first speaker 41 and the third microphone 51M are located at the same position and face the same front direction. In this case, the first speaker 41 and the third microphone 51M can be configured as one module (sensor for both transmission and reception).

As shown in FIGS. 23B to 23E, the autonomous moving apparatus 100 may include a first microphone 51L1, a second microphone 51L2, a third microphone 51R1, and a fourth microphone 51R2, each of which is attached to the vehicle body 190, receives an acoustic wave reflected by an object, and converts the acoustic wave into an electric signal. Positions and orientations of the first speaker 41, the first microphone 51L1, the second microphone 51L2, the third microphone 51R1, and the fourth microphone 51R2 are plane symmetrical, relative to the center plane C1 as a single target plane. The first microphone 51L1, the second microphone 51L2, the third microphone 51R1, and the fourth microphone 51R2 may be attached to the front end F1 of the vehicle body 190 to face a front direction (FIG. 23C). The two microphones 51L1 and 51R1 may be attached to face the outside of the vehicle body 190 in the left-right direction, and the other two microphones 51L2 and 51R2 may be attached to face an oblique front direction or a front direction (FIGS. 23D and 23E).

As shown in FIGS. 23A to 23E, even if the number of speakers or microphones attached to the vehicle body 190 increases, all of speakers and microphones are attached plane symmetrically, relative to the single target plane C1. This can reduce the left-right deviation of sound pressures of acoustic waves received by the first microphone 51L1, the second microphone 51L2, the third microphone 51R1, and the fourth microphone 51R2.

The above-described embodiments are examples of the present invention. Therefore, the present invention is not limited to the above-described embodiments, and it is needless to say that, even in forms other than the embodiments, various modifications are possible according to a design or the like without deviating from a technical concept according to the present invention.

Acoustic waves which have entered through openings of the vehicle body 190 or the casing 210 are reflected inside the vehicle body 190 or the casing 210, and can be received by the first microphone 51L and the second microphone 51R as echo signals (noise). Therefore, as shown in FIG. 12 or 17A, only openings for the first microphone 51L and the second microphone 51R to receive acoustic waves, and an opening for the first speaker 41 to output an acoustic wave may be formed in the casings 210, 220L, and 220R as the openings, for example. This can reduce the number of openings which allow acoustic waves to enter the interior of the casing 210, and therefore it is possible to reduce acoustic waves entering the interior of the casing 210. Further, FIG. 12 shows an example in which an opening for outputting an acoustic wave is formed in the casing 210, because the first speaker 41 is disposed on the outside of the casing 210, that is, inside of the outer edge of the casing 210. However, the speaker is not limited thereto, and the entire first speaker 41 may be disposed on the outer periphery of the casing 210, that is, inside of the outer edge of the casing 210. This eliminates the necessity of an opening for the first speaker 41, and it is possible to further reduce the number of openings which allow acoustic waves to enter the interior of the casing 210. Further, if there is a gap between the outer periphery of the first microphone 51L and the second microphone 51R and the inner periphery of an opening, an acoustic wave enters through the gap, and this causes an increase in noise. Therefore, as shown in FIG. 22B, the composite unit 300 may further include a microphone mounted substrate 215L on which the first microphone 51L is mounted, and a sealing member 216L which is made of a rubber packing or the like and closes a gap between the casing 210 and the microphone mounted substrate 215L. The sealing member 216L is arranged to surround the periphery of the first microphone 51L including a left-right direction and an up-down direction of the first microphone 51L. The gap between the outer periphery of the first microphone 51L and the second microphone 51R and the inner periphery of the opening is closed due to the configuration. This can reduce noise entering through the gap. The gap may be made smaller or closed by reducing or eliminating the difference between the outer diameter of the first microphone 51L and the second microphone 51R and the inner diameter of the opening. It is needless to say that the composite unit 300 can be implemented as the autonomous moving apparatus 100 by replacing the casing 210 with the vehicle body 190.

### Supplementary Notes

### Supplementary Note 1: First Embodiment, FIGS. 6A to 8: Increasing Difference in Left and Right Sound Pressures

The autonomous moving apparatus 100 includes: the vehicle body 190; the first speaker 41 that is attached to the vehicle body 190 and transmits an acoustic wave toward an area including a front direction of the vehicle body 190; and the first microphone 51L and the second microphone 51R that are attached to the vehicle body 190, receive acoustic waves reflected by an object, and convert the acoustic waves into electric signals. When viewed from a vertical direction, the first speaker 41, the first microphone 51L, and the second microphone 51R are located on an outside or outer periphery of the vehicle body 190. The first speaker 41 is interposed between the first microphone 51L and the second microphone 51R in a left-right direction perpendicular to a front direction. Distances from the first speaker 41 or a center of gravity of a plurality of speakers including the first speaker 41, to each of the first microphone 51L and the second microphone 51R in a left-right direction are equal.

### Supplementary Note 2: Second Embodiment, FIGS. 7E to 7H: Increasing Sound Pressure in Front Direction

In the autonomous moving apparatus 100 according to Supplementary note 1, the first speaker 41 is disposed at the front end F1 of the vehicle body 190.

### Supplementary Note 3: Second Embodiment, FIGS. 7E to 7H: Contact Detection Sensor

The autonomous moving apparatus 100 according to Supplementary note 2 further includes: the contact detection sensor 214 that detects contact with an object and is disposed in a front direction of the first speaker 41 or disposed at the same position in a front-rear direction as the first speaker 41.

### Supplementary Note 4: Third Embodiment, FIGS. 9 to 12: Reducing Noise in Rear Direction

In the autonomous moving apparatus 100 according to any one of Supplementary notes 1 to 3, the vehicle body 190 includes the sound pressure reducing units 210aL and 210aR that are disposed in a rear direction of the first microphone 51L and the second microphone 51R and reduce sound pressures of transmitted acoustic waves.

### Supplementary Note 5: Fourth Embodiment, FIGS. 13 to 14B: Increasing Sound Pressure in Oblique Front Direction

The autonomous moving apparatus 100 according to any one of Supplementary notes 1 to 4 further includes: the first reflecting member 211L that reflects an acoustic wave and is at least partially disposed in a rear direction of the first microphone 51L; and the second reflecting member 211R that reflects an acoustic wave and is at least partially disposed in a rear direction of the second microphone 51R. The first microphone 51L and the second microphone 51R face a left-right direction and an outside of the vehicle body 190, and reflecting surfaces of the first reflecting member 211L and the second reflecting member 211R face a front direction.

### Supplementary Note 6: Fourth Embodiment, FIGS. 15A and 15B: Increasing Sound Pressure in Oblique Front Direction

The autonomous moving apparatus 100 according to any one of Supplementary notes 1 to 4 further includes: the first reflecting member 212L that reflects an acoustic wave and is at least partially disposed in an inner side of the vehicle body 190 in a left-right direction of the first microphone 51L; and the second reflecting member 212R that reflects an acoustic wave and is at least partially disposed in an inner side of vehicle body 190 in a left-right direction of the second microphone 51R. The first microphone 51L and the second microphone 51R face a front direction, and reflecting surfaces of the first reflecting member 212L and the second reflecting member 212R face an outside in a left-right direction.

### Supplementary Note 7: Fourth Embodiment, FIGS. 16 to 17B: Increasing Sound Pressure in Oblique Front Direction

In the autonomous moving apparatus 100 according to any one of Supplementary notes 1 to 4, orientations of the first microphone 51L and the second microphone 51R are inclined from a front direction to an outside of the vehicle body 190 in a left-right direction.

### Supplementary Note 8: Fifth Embodiment, FIGS. 18A to 18C: Reducing Sound Pressures from Right and Left Opposite Sides

In the autonomous moving apparatus 100 according to any one of Supplementary notes 1 to 7, the vehicle body 190 includes: the first sound pressure reducing unit 210bL that reduces a sound pressure of a transmitted acoustic wave, and that is located on an outside of the vehicle body 190 and on an outside of the first line segment connecting the first speaker 41 and the first microphone 51L, when viewed from the vertical direction; and the second sound pressure reducing unit 210bR that reduces a sound pressure of a transmitted acoustic wave, and that is located on an outside the vehicle body 190 and on an outside of the second line segment connecting the first speaker 41 and the second microphone 51R, when viewed from the vertical direction.

### Supplementary Note 9: Sixth Embodiment, FIG. 19: Reducing Sound Pressure Reflected by Unevenness on Ground

The autonomous moving apparatus 100 according to any one of Supplementary notes 1 to 8 further includes: the projecting member 213 that reduces a sound pressure of a transmitted acoustic wave, and that projects in a traveling direction of an acoustic wave from a lower portion of at least one of the first speaker 41, the first microphone 51L, and the second microphone 51R.

### Supplementary Note 10: Seventh Embodiment, FIG. 20: Increasing Sound Pressure in Lateral Direction

In the autonomous moving apparatus 100 according to Supplementary note 5, an entirety of the first reflecting member 211L is disposed in a rear direction of the first microphone 51L, and an entirety of the second reflecting member 211R is disposed in a rear direction of the second microphone 51R.

### Supplementary Note 11: Eighth Embodiment, FIG. 21: Increasing Sound Pressure in Front Direction

In the autonomous moving apparatus 100 according to Supplementary note 6, an entirety of the first reflecting member 212L is disposed in the inner side of the vehicle body 190 in a left-right direction of the first microphone 51L, and an entirety of the second reflecting member 212R is disposed in the inner side of the vehicle body 190 in a left-right direction of the second microphone 51R.

### Supplementary Note 12: Ninth Embodiment, FIGS. 22A and 22B: Increasing Sound Pressure in Lateral Direction, Front Direction/Lateral Direction

In the autonomous moving apparatus 100 according to Supplementary note 7, a portion of the first microphone 51L that receives an acoustic wave and a portion of the second microphone 51R that receives an acoustic wave are visible from an outside of the vehicle body 190 in at least one of a front direction and a left-right direction.

### Supplementary Note 13: Ninth Embodiment, FIG. 22B: Increasing Sound Pressure in Lateral Direction, Front Direction/Lateral Direction

The autonomous moving apparatus 100 according to Supplementary note 12 further includes: the first reflecting member 211L that is disposed in the periphery of the first microphone 51L and reflects an acoustic wave toward the portion of the first microphone 51L which receives the acoustic wave; and the second reflecting member 211R that is disposed in the periphery of the second microphone 51R and reflects an acoustic wave toward the portion of the second microphone 51R which receives the acoustic wave.

### Supplementary Note 14: Tenth Embodiment, FIGS. 23A to 23E

The autonomous moving apparatus 100 according to any one of Supplementary notes 1 to 13 further includes: the second speaker 41R that is attached to the vehicle body 190 and transmits an acoustic wave in a front direction; and the third microphone 51M that is attached to the vehicle body 190, receives an acoustic wave reflected by an object, and converts the acoustic wave into an electric signal. The first speaker 41L, the second speaker 41R, the first microphone 51L, the second microphone 51R, and the third microphone 51M are disposed plane symmetrically, relative to the single target plane C1.

### Supplementary Note 15: Structure for Closing Gap

The autonomous moving apparatus 100 according to any one of Supplementary notes 1 to 14 further includes: a first microphone mounted substrate 215L on which the first microphone 51L is mounted; a first sealing member 216L that closes a gap between the vehicle body 190 and the first microphone mounted substrate 215L; a second microphone mounted substrate on which the second microphone 51R is mounted; and a second sealing member that closes a gap between the vehicle body 190 and the second microphone mounted substrate.

### Supplementary Note 16: Composite Unit Used in Autonomous Moving Apparatus

The composite unit 300 used in the autonomous moving apparatus 100 includes: the casing 210; the first speaker 41 that is attached in the casing 210 and transmits an acoustic wave toward an area including a front direction of the casing 210; and the first microphone 51L and the second microphone 51R that are attached in the casing 210, receive acoustic waves reflected by an object, and convert the acoustic waves into electric signals. When the composite unit 300 is viewed from the vertical direction, the first speaker 41, the first microphone 51L, and the second microphone 51R are located on an outside or outer periphery of the casing 210. The first speaker 41 is interposed between the first microphone 51L and the second microphone 51R in a left-right direction perpendicular to the front direction. Distances from the first speaker 41 or a center of gravity of a plurality of speakers including the first speaker 41, to each of the first microphone 51L and the second microphone 51R in a left-right direction are equal.

### Supplementary Note 17: Composite Unit Used in Autonomous Moving Apparatus

The autonomous moving apparatus 100 includes the composite unit 300 according to Supplementary note 16.

### Supplementary Note 18

The autonomous moving apparatus 100 according to Supplementary note 17 further includes: a structure surrounding a bottom surface and a top surface of the composite unit 300. Due to the presence of the structure, it is possible to reduce a sound pressure of an acoustic wave that comes from a rear direction of the autonomous moving apparatus 100, comes around the bottom surface and the top surface of the composite unit 300, and enters the first microphone 51L and the second microphone 51R.

### Supplementary Note 19: Digital Pheromone+Echolocation

The autonomous moving apparatus 100 autonomously moves using a radio wave and an acoustic wave. The autonomous moving apparatus includes: the receiving unit 110 that receives a radio wave; the angle estimating unit 134 that estimates an incoming direction of a radio wave; the first speaker 41 that transmits an acoustic wave toward a straight-travelling direction of the autonomous moving apparatus 100; the first microphone 51L and the second microphone 51R that receive acoustic waves reflected by an object and convert the acoustic waves into a first sound signal and a second sound signal; and the operation control unit 135 that controls a movement direction of the autonomous moving apparatus 100 based on the first sound signal, the second sound signal, and the incoming direction of the radio wave.

### Supplementary Note 20

In the autonomous moving apparatus 100 according to Supplementary note 18, the operation control unit 135 controls a movement direction of the autonomous moving apparatus 100 based on echo signals included in a first sound signal and a second sound signal and an incoming direction of a radio wave.

The entire contents of Japanese Patent Application No. 2022-181345 (filed on Nov. 11, 2022 in Japan) are incorporated herein by reference, to thereby take some protection against translation errors or omitted portions.

### REFERENCE SIGNS LIST

41, 41L First speaker
41R Second speaker
51L, 51L1 First microphone
51M Third microphone
51R, 51R1 Second microphone
60A, 60B Object
100 Autonomous moving apparatus
190 Vehicle body
214 Contact detection sensor
210 Casing
210aL, 210aR Sound pressure reducing unit
210bL First sound pressure reducing unit
210bR Second sound pressure reducing unit
211L, 212L First reflecting member
211R, 212R Second reflecting member
213 Projecting member
300 Composite unit
C1 Single target plane
F1 Front end of vehicle body
F2 Front end of casing

1. An autonomous moving apparatus comprising:
a vehicle body;
a first speaker that is attached to the vehicle body and transmits an acoustic wave toward an area including a front direction of the vehicle body;
a first microphone that is attached to the vehicle body, receives an acoustic wave reflected by an object, and converts the acoustic wave into an electric signal; and
a second microphone that is attached to the vehicle body, receives an acoustic wave reflected by the object, and converts the acoustic wave into an electric signal, wherein
when viewed from a vertical direction, the first speaker, the first microphone, and the second microphone are located on an outside or an outer periphery of the vehicle body,
the first speaker is interposed between the first microphone and the second microphone in a left-right direction perpendicular to the front direction, and
distances from the first speaker or a center of gravity of a plurality of speakers including the first speaker, to each of the first microphone and the second microphone in the left-right direction are equal.

2. The autonomous moving apparatus according to claim 1, wherein
the first speaker is disposed at a front end of the vehicle body.

3. The autonomous moving apparatus according to claim 2 further comprising:
a contact detection sensor that detects contact with the object and is disposed in a front direction of the first speaker or disposed at the same position in a front-rear direction as the first speaker.

4. The autonomous moving apparatus according to claim 1, wherein
the vehicle body includes a sound pressure reducing unit that is disposed in a rear direction of the first microphone and in a rear direction of the second microphone, and reduces a sound pressure of a transmitted acoustic wave.

5. The autonomous moving apparatus according to claim 1 further comprising:
a first reflecting member that reflects an acoustic wave and is at least partially disposed in the rear direction of the first microphone; and
a second reflecting member that reflects an acoustic wave and is at least partially disposed in the rear direction of the second microphone, wherein
the first microphone and the second microphone face the left-right direction and an outside of the vehicle body, and
reflecting surfaces of the first reflecting member and the second reflecting member face the front direction.

6. The autonomous moving apparatus according to claim 1 further comprising:
a first reflecting member that reflects an acoustic wave and is at least partially disposed in an inner side of the vehicle body in the left-right direction of the first microphone; and
a second reflecting member that reflects an acoustic wave and is at least partially disposed in an inner side of the vehicle body in the left-right direction of the second microphone, wherein
the first microphone and the second microphone face the front direction, and
reflecting surfaces of the first reflecting member and the second reflecting member face an outside in the left-right direction.

7. The autonomous moving apparatus according to claim 1, wherein
orientations of the first microphone and the second microphone are inclined from the front direction to an outside of the vehicle body in the left-right direction.

8. The autonomous moving apparatus according to claim 1, wherein
the vehicle body includes:
a first sound pressure reducing unit that reduces a sound pressure of a transmitted acoustic wave, and that is located on an outside of the vehicle body and on an outside of a first line segment connecting the first speaker and the first microphone, when viewed from the vertical direction; and
a second sound pressure reducing unit that reduces a sound pressure of a transmitted acoustic wave, and that is located on the outside the vehicle body and on an outside of a second line segment connecting the first speaker and the second microphone, when viewed from the vertical direction.

9. The autonomous moving apparatus according to claim 1 further comprising:
a projecting member that reduces the sound pressure of the transmitted acoustic wave, and that projects in a traveling direction of the acoustic wave from a lower portion of at least one of the first speaker, the first microphone, and the second microphone.

10. The autonomous moving apparatus according to claim 5, wherein
an entirety of the first reflecting member is disposed in the rear direction of the first microphone, and
an entirety of the second reflecting member is disposed in the rear direction of the second microphone.

11. The autonomous moving apparatus according to claim 6, wherein
an entirety of the first reflecting member is disposed in the inner side of the vehicle body in the left-right direction of the first microphone, and
an entirety of the second reflecting member is disposed in the inner side of the vehicle body in the left-right direction of the second microphone.

12. The autonomous moving apparatus according to claim 7, wherein
a portion of the first microphone that receives an acoustic wave and a portion of the second microphone that receives an acoustic wave are visible from the outside of the vehicle body in at least one of the front direction and the left-right direction.

13. The autonomous moving apparatus according to claim 12 further comprising:
a first reflecting member that is disposed in the periphery of the first microphone and reflects the acoustic wave toward the portion of the first microphone which receives the acoustic wave; and
a second reflecting member that is disposed in the periphery of the second microphone and reflects the acoustic wave toward the portion of the second microphone which receives the acoustic wave.

14. The autonomous moving apparatus according to claim 1 further comprising:
a second speaker that is attached to the vehicle body and transmits an acoustic wave in the front direction; and
a third microphone that is attached to the vehicle body, receives an acoustic wave reflected by the object, and converts the acoustic wave into an electric signal, wherein
the first speaker, the second speaker, the first microphone, the second microphone, and the third microphone are disposed plane symmetrically relative to a single target plane.

15. The autonomous moving apparatus according to claim 1 further comprising:
a first microphone mounted substrate on which the first microphone is mounted;
a first sealing member that closes a gap between the vehicle body and the first microphone mounted substrate;
a second microphone mounted substrate on which the second microphone is mounted; and
a second sealing member that closes a gap between the vehicle body and the second microphone mounted substrate.

16. A composite unit of a speaker-microphone for an autonomous moving apparatus that is a composite unit used in an autonomous moving apparatus, the composite unit comprising:
a casing;
a first speaker that is attached in the casing and transmits an acoustic wave toward an area including a front direction of the casing;
a first microphone that is attached in the casing, receives an acoustic wave reflected by an object, and converts the acoustic wave into an electric signal; and
a second microphone that is attached in the casing, receives an acoustic wave reflected by the object, and converts the acoustic wave into an electric signal, wherein
when viewed from a vertical direction, the first speaker, the first microphone, and the second microphone are located on an outside or an outer periphery of the casing,
the first speaker is interposed between the first microphone and the second microphone in a left-right direction perpendicular to the front direction, and
distances from the first speaker or a center of gravity of a plurality of speakers including the first speaker, to each of the first microphone and the second microphone in the left-right direction are equal.

17. An autonomous moving apparatus comprising:
the composite unit according to claim 16.
